(19) United States
(12) Patent Application Publication
(10) Pub. No.: US 2019/0160630 A1
(43) Pub. Date: May 30, 2019

(54) ABRASIVE ARTICLES AND METHODS OF FORMING SAME

(71) Applicants: SAINT-GOBAIN ABRASIVES, INC., Worcester, MA (US); SAINT-GOBAIN ABRASIFS, Conflans-Sainte-Honorine (FR)

(72) Inventors: Yi JIANG, Shrewsbury, MA (US); Warren V. GLEASON, Charlton, MA (US); Patrick J. MALONE, Hamburg (DE); Charles A. BATEMAN, Rutland, MA (US); Doruk O. YENER, Bedford, MA (US); Mark HAMPDEN-SMITH, Chelmsford, MA (US)

(21) Appl. No.: 16/204,417

(22) Filed: Nov. 29, 2018

Related U.S. Application Data
(60) Provisional application No. 62/592,745, filed on Nov. 30, 2017.

(51) Int. Cl. B24D 3/00; B24D 11/02

(52) U.S. Cl. CPC B24D 3/00; B24D 11/02

(57) ABSTRACT

A coated abrasive article comprising a backing and abrasive particles overlying the backing, the abrasive particles having a random rotational orientation and at least 87% of the abrasive particles are oriented at a tilt angle within a range of greater than 44 degrees to 90 degrees, and not greater than 13% of the abrasive particles are oriented at a tilt angle of not greater than 44 degrees.

### CROSS-REFERENCE TO RELATED APPLICATION

This Application claims priority under 35 U.S.C. § 119(e) to U.S. Provisional Application No. 62/592,745 entitled “ABRASIVE ARTICLES AND METHODS OF FORMING SAME” by Yi JIANG, et al., filed Nov. 30, 2017, which is assigned to the current assignee hereof and is incorporated herein by reference in its entirety.

### BACKGROUND

### Field of the Disclosure

The following is directed to abrasive articles, and in particular coated abrasive articles and methods of forming coated abrasive articles.

### Description of the Related Art

Abrasive articles incorporating abrasive particles are useful for various material removal operations including grinding, finishing, polishing, and the like. Depending upon the type of abrasive material, such abrasive particles can be useful in shaping or grinding various materials in the manufacturing of goods. Certain types of abrasive particles have been formulated to date that have particular geometries, such as triangular abrasive particles and abrasive articles incorporating such objects. See, for example, U.S. Pat. Nos. 5,201,916; 5,366,523; and 5,984,988.

Previously, three basic technologies that have been employed to produce abrasive particles having a specified shape, which are fusion, sintering, and chemical ceramic. In the fusion process, abrasive particles can be shaped by a chill roll, the face of which may or may not be engraved, a mold into which molten material is poured, or a heat sink material immersed in an aluminum oxide melt. See, for example, U.S. Pat. No. 3,377,660. In sintering processes, abrasive particles can be formed from refractory powders having a particle size of up to 10 micrometers in diameter. Binders can be added to the powders along with a lubricant and a suitable solvent to form a mixture that can be shaped into platelets or rods of various lengths and diameters. See, for example, U.S. Pat. No. 3,079,243. Chemical ceramic technology involves converting a colloidal dispersion or hydrosol (sometimes called a sol) to a gel or any other physical state that restrains the mobility of the components, drying, and firing to obtain a ceramic material. See, for example, U.S. Pat. Nos. 4,744,802 and 4,848,041. Other relevant disclosures on abrasive particles and associated methods of forming and abrasive articles incorporating such particles are available at: http://www.abel-ip.com/publications/.

The industry continues to demand improved abrasive materials and abrasive articles.

### SUMMARY

According to one aspect, a coated abrasive article includes a backing and abrasive particles overlying the backing, wherein the abrasive particles have a random rotational orientation and at least 87% of the abrasive particles are oriented at a tilt angle within a range of greater than 44 degrees to 90 degrees, and wherein not greater than 13% of the abrasive particles are oriented at a tilt angle of not greater than 44 degrees.

In another aspect, a coated abrasive article includes a backing and abrasive particles overlying the backing, wherein the abrasive particles have a random rotational orientation, and wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and wherein the abrasive particles have a primary orientation value (P1/P2) of at least 2.5.

In still another aspect, a coated abrasive article includes a backing and abrasive particles overlying the backing, wherein the abrasive particles have a random rotational orientation, and wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and a third portion (P3) of the abrasive particles have a flat orientation having a tilt angle within a range of 0 degrees to 44 degrees, and wherein the abrasive particles have a tertiary orientation value (P1/P3) of at least 4.0.

According to yet another aspect, a method for forming an abrasive article comprises containing abrasive particles on a substrate and projecting the abrasive particles from the substrate onto a backing using electrostatic force to project the particles vertically across a gap between the substrate and the backing and onto the backing, wherein the substrate comprises a resistivity of not greater than 1E+14 Ωcm.

In still another aspect, a method for forming an abrasive article comprises containing abrasive particles on a substrate and projecting the abrasive particles from the substrate onto a backing using electrostatic force to project the particles across a gap between the substrate and the backing and onto the backing, wherein projecting is conducted at a projection efficiency of at least 90%.

For one aspect, a method for forming an abrasive article comprises containing abrasive particles on a substrate comprising a first portion and a second portion overlying at least some of the first portion, wherein the second portion comprises a resistivity less than a resistivity of the first portion, and wherein the abrasive particles are in contact with the second portion, and further wherein the method includes projecting the abrasive particles from the substrate onto a backing using electrostatic force.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a system for forming a coated abrasive article according to an embodiment.

FIG. 2 includes an illustration of a system for forming a coated abrasive article according to an embodiment.

FIG. 3 includes an illustration of a system for forming a coated abrasive article according to an embodiment.

FIG. 4 includes an illustration of a system for forming a coated abrasive article according to an embodiment.

FIG. 5 includes an illustration of a containment region for forming a coated abrasive article according to an embodiment.

FIG. 6 includes an illustration of a containment region for forming a coated abrasive article according to an embodiment.

FIG. 7A includes a top-view illustration of a portion of a coated abrasive article according to an embodiment.

FIG. 7B includes a top-view illustration of a portion of a coated abrasive article according to an embodiment.

FIG. 8A includes a side-view illustration of abrasive particles on a backing according to an embodiment.

FIG. 8B includes a side-view illustration of a particle on a backing having a tilt angle according to an embodiment.

FIG. 8C includes a top-down illustration of the particle of FIG. 8B.

FIG. 8D includes a side-view illustration of a particle on a backing having a tilt angle according to an embodiment.

FIG. 8E includes a top-down illustration of the particle of FIG. 8D.

FIG. 9 includes a top-down image of a coated abrasive according to an embodiment.

FIG. 10A includes a perspective view illustration of a shaped abrasive particle according to an embodiment.

FIG. 10B includes a top-down view illustration of a shaped abrasive particle according to an embodiment

FIG. 11 includes a perspective view illustration of a shaped abrasive particle according to an embodiment.

FIG. 12A includes a perspective view illustration of a controlled height abrasive particle according to an embodiment.

FIG. 12B includes a perspective view illustration of a non-shaped particle according to an embodiment.

FIG. 13 includes a cross-sectional illustration of a coated abrasive article incorporating the abrasive particulate material in accordance with an embodiment.

FIG. 14 includes a top-view illustration of a portion of a coated abrasive article according to an embodiment.

FIG. 15 includes a cross-sectional illustration of a portion of a coated abrasive article according to an embodiment.

FIG. 16 includes plots demonstrating the orientation of a conventional coated abrasive sample and samples representative of embodiments herein.

FIGS. 17-19 include images of portions of coated abrasive articles including representative samples and a conventional sample.

FIG. 20 includes an illustration of the relationship between eccentricity and orientation for an abrasive particle

FIG. 21 includes a thresholded image of FIG. 17.

FIG. 22 an image of a portion of a containment region according to an embodiment.

FIG. 23 includes a top-down image of a portion of a containment region including abrasive particles prior to coating on a substrate.

FIG. 24 includes a top-down image of a portion of the abrasive article including abrasive particles attached to a backing after a projection process according to an embodiment.

FIG. 25 includes a top-down image of shaped abrasive particles contained in a containment region according to an embodiment.

FIG. 26 includes a top-down image of shaped abrasive particles attached to a tape after projection according to an embodiment.

### DETAILED DESCRIPTION

The following is directed to methods of forming abrasive articles, such as fixed abrasive articles, and more particularly coated abrasive articles. The abrasive articles may be used in a variety of material removal operations for a variety of work pieces.

FIG. 1 includes an illustration of a system for forming a coated abrasive article according to an embodiment. As shown in FIG. 1, a system 100 for forming a coated abrasive article can include a backing 101 having a receiving surface 102. Opposite the receiving surface 102 there can be a substrate 103 having a substrate surface 104 facing the receiving surface 102 of the backing 101. The receiving surface 102 and the substrate surface 104 can be parallel to each other. As further illustrated, abrasive particles 105 can be overlying the substrate 103 and in contact with at least a portion of the substrate surface 104.

The system 100 can also include a first electrode 107 underlying the substrate 103. The first electrode 107 can be spaced apart from the substrate 103 and in particular can be separate from the substrate surface 104. The first electrode 107 can include one or more conventional electrodes.

The system can further include a second electrode 108 near the backing 101. The second electrode 108 can be opposite the receiving surface 102 of the backing 101, and in particular, can be spaced apart from the backing 101 and the receiving surface 102 of the backing 101. The first electrode 107 and the second electrode 108 can be configured to create an electrical field there between, which can facilitate electrostatic projection of particles from the substrate surface 104 to the receiving surface 102. Notably, the electrodes 107 and 108 can be configured to create an electrostatic force sufficient to project particles (e.g., the abrasive particles 105) vertically across a gap between the substrate 103 and the backing 101. The abrasive particles 105 can be projected with sufficient force to facilitate attachment of the abrasive particles 105 to the receiving surface 103 of the backing 101. As will be appreciated, the backing can include one or more adhesive layers, which can define the receiving surface 102 and facilitate attachment of the abrasive particles 105 to the backing 101.

In one embodiment, the substrate 103 may have a particular bulk resistivity that may facilitate improved projection of the abrasive particles 105 and thus may further facilitate improved placement and/or orientation of the abrasive particles on backing 101. According to one embodiment, the substrate 103 can have a bulk resistivity of not less than 1E-6 Ωcm, such as not less than 1E-5 Ωcm or not less than 1E-4 Ωcm or not less than 1E-3 Ωcm or not less than 1E-2 Ωcm or not less than 1E-1 Ωcm or not less than 1 Ωcm or not less than 1E+1 Ωcm or not less than 1E+2 Ωcm or not less than 1E+3 Ωcm or not less than 1E+4 Ωcm or not less than 1E+5 Ωcm or not less than 1E+6 Ωcm or not less than 1E+7 Ωcm or not less than 1E+8 Ωcm or not less than 1E+9 Ωcm or not less than 1E+10 Ωcm. Still, in one non-limiting embodiment, the bulk resistivity of the substrate can be not greater than 1E+14 Ωcm or not greater than 1E+13 Ωcm or not greater than 1E+12 Ωcm or not greater than 1E+11 Ωcm or not greater than 1E+10 Ωcm or not greater than 1E+9 Ωcm or not greater than 1E+8 Ωcm or not greater than 1E+7 Ωcm or not greater than 1E+6 Ωcm or not greater than 1E+5 Ωcm or not greater than 1E+4 Ωcm or not greater than 1E+3 Ωcm or not greater than 1E+2 Ωcm or not greater than 1E+1 Ωcm or not greater than 1 Ωcm or not greater than 1E-1 Ωcm or not greater than 1E-2 Ωcm or not greater than 1E-3 Ωcm or not greater than 1E-4 Ωcm or not greater than 1E-5 Ωcm. It will be appreciated that the bulk resistivity can be within a range including any of the minimum and maximum values noted above. Bulk resistivity is measured according to ASTM D257. Reference herein to resistivity will be understood to refer to bulk resistivity unless otherwise stated.

The substrate 103 may have a particular surface resistivity that may facilitate improved projection of the abrasive particles 105 and thus may further facilitate improved placement and/or orientation of the abrasive particles on the backing 101. According to one embodiment, the substrate 103 can have a surface resistivity of not less than 1E-6 Ω/sq., such as not less than 1E-5 Ω/sq or not less than 1E-4 Ω/sq or not less than 1E-3 Ω/sq or not less than 1E-2 Ω/sq or not less than 1E-1 Ω/sq or not less than 1 Ω/sq or not less than 1E+1 Ω/sq or not less than 1E+2 Ω/sq or not less than 1E+3 Ω/sq or not less than 1E+4 Ω/sq or not less than 1E+5 Ω/sq or not less than 1E+6 Ω/sq or not less than 1E+7 Ω/sq or not less than 1E+8 Ω/sq or not less than 1E+9 Ω/sq or not less than 1E+10 Ω/sq. Still, in one non-limiting embodiment, the surface resistivity of the substrate 103 can be not greater than 1E+14 Ω/sq or not greater than 1E+13 Ω/sq or not greater than 1E+12 Ω/sq or not greater than 1E+11 Ω/sq or not greater than 1E+10 Ω/sq or not greater than 1E+9 Ω/sq or not greater than 1E+8 Ω/sq or not greater than 1E+7 Ω/sq or not greater than 1E+6 Ω/sq or not greater than 1E+5 Ω/sq or not greater than 1E+4 Ω/sq or not greater than 1E+3 Ω/sq or not greater than 1E+2 Ω/sq or not greater than 1E+1 Ω/sq or not greater than 1 Ω/sq or not greater than 1E-1 Ω/sq or not greater than 1E-2 Ω/sq or not greater than 1E-3 Ω/sq or not greater than 1E-4 Ω/sq or not greater than 1E-5 Ω/sq. It will be appreciated that the surface resistivity can be within a range including any of the minimum and maximum values noted above. Resistivity (surface and/or bulk) is measured according to ASTM D257 for insulating materials having a resistivity of greater than 1×10⁴ Ωcm. Resistivity (surface and/or bulk) of conductive materials (i.e., resistivity of not greater than 1×10⁴ Ωcm) is measured according to ASTM D4496.

According to another embodiment, the substrate 103 may have a particular resistivity ratio (Sr/Br), wherein Sr is the surface resistivity and Br represents the bulk resistivity of the substrate 103. Use of a suitable resistivity ratio may facilitate improved projection of the abrasive particles and may further facilitate improved placement and/or orientation of the abrasive particles on the backing 101. According to one embodiment the resistivity ratio (Sr/Br) can be at least 0.5 cm⁻¹, such as at least 0.6 cm⁻¹ or at least 0.7 cm⁻¹ or at least 0.8 cm⁻¹ or at least 0.9 cm⁻¹ or at least 1 cm⁻¹ or at least 1.1 cm⁻¹ or at least 1.2 cm⁻¹ or at least 1.3 cm⁻¹ or at least 1.5 cm⁻¹ or at least 1.7 cm⁻¹ or at least 2 cm⁻¹ or at least 3 cm⁻¹ or at least 4 cm⁻¹ or at least 5 cm⁻¹. Still, in at least one embodiment, the resistivity ratio (Sr/Br) of the substrate 103 can be not greater than 1E+5 cm⁻¹ or not greater than 1E+4 cm⁻¹ or not greater than 1E+3 cm⁻¹ or not greater than 1E+2 cm⁻¹ or not greater than 1E+1 cm⁻¹ or not greater than 9 cm⁻¹ or not greater than 8 cm⁻¹ or not greater than 7 cm⁻¹ or not greater than 5 cm⁻¹ or not greater than 3 cm⁻¹. It will be appreciated that the resistivity ratio can be within a range including any of the minimum and maximum values noted above.

In one aspect, the substrate 103 can be made of a particular material. For example, the substrate 103 can include a material selected from the group consisting of a polymer, metal, metal alloy, ceramic, glass, carbon, or any combination thereof.

Using the system 100, a method for forming an abrasive article can include containing the abrasive particles 105 on the substrate 103 and projecting the abrasive particles 105 from the substrate 103 onto the backing 101 using an electrostatic force to project the abrasive particles 105 vertically across a gap between the substrate 103 and the backing 101 and onto the backing 101. In one particular embodiment, the majority of the abrasive particles 105 on the substrate 103 are lying flat with a major surface of the particle in contact with the substrate. Moreover, the majority of the abrasive particles, if not all of the abrasive particles 105, can be on the substrate 103 in a random arrangement, such as randomly placed on the surface, such that the abrasive particles 105 on the substrate 103 lack any predetermined positions and predetermined orientations.

In certain instances, the system 100 and associated method may facilitate improved projection efficiency of the abrasive particles from the substrate 103 to the backing 101. The projection efficiency may be measured as the percentage of particles (e.g., abrasive particles 105) that are projected for all of the particles that are contained on the substrate. It will be appreciated that such a percentage can be calculated by number of particles or weight of the particles. It is desirable to have a high projection efficiency during the projection process, because particles that are not projected properly, are not sufficiently adhered to the backing 101, and/or fall off of the backing after initial projection, represent wasted product and a process inefficiency. According to one embodiment, the projection process can be conducted at a projection efficiency of at least 90%, such as or at least 91% or at least 92% or at least 93% or at least 94% or at least 95% or at least 96% or at least 97% or at least 98% or at least 99%. In one non-limiting embodiment, the projection efficiency can be not greater than 99.9% such as not greater than 99.5% or not greater than 99% or not greater than 98%. It will be appreciated that the projection efficiency can be within a range including any of the minimum and maximum percentages noted above, including for example, a projection efficiency within a range of at least 90% and not greater than 99.9%. It will be appreciated that such a percentage can be calculated based on the number of particles or weight of the particles.

In another aspect, the process of projecting the particles (e.g., abrasive particles 105) from the substrate 103 to the backing 101 may have particularly low projection inefficiency, which is a measure of those particles that are not projected or projected incompletely for the total number (or weight) of particles on the substrate. The projection inefficiency can be described as a percentage of those particles that were not projected effectively onto the backing 101 after projection compared to the total number of particles originally contained on the substrate prior to projection. It will be appreciated that such a percentage can be calculated by number of particles or weight of the particles. In one embodiment, the projection inefficiency can be not greater than 10%, such as not greater than 9% or not greater than 8% or not greater than 7% or not greater than 6% or not greater than 5% or not greater than 4% or not greater than 3% or not greater than 2% or not greater than 1% of the particles on the substrate 103. In still another non-limiting embodiment, the projection inefficiency can be at least 0.1% or at least 0.5% or at least 1% or at least 2%. It will be appreciated that the projection inefficiency can be within a range including any of the minimum and maximum percentages noted above, including for example, a projection inefficiency within a range of at least 0.1% and not greater than 10%.

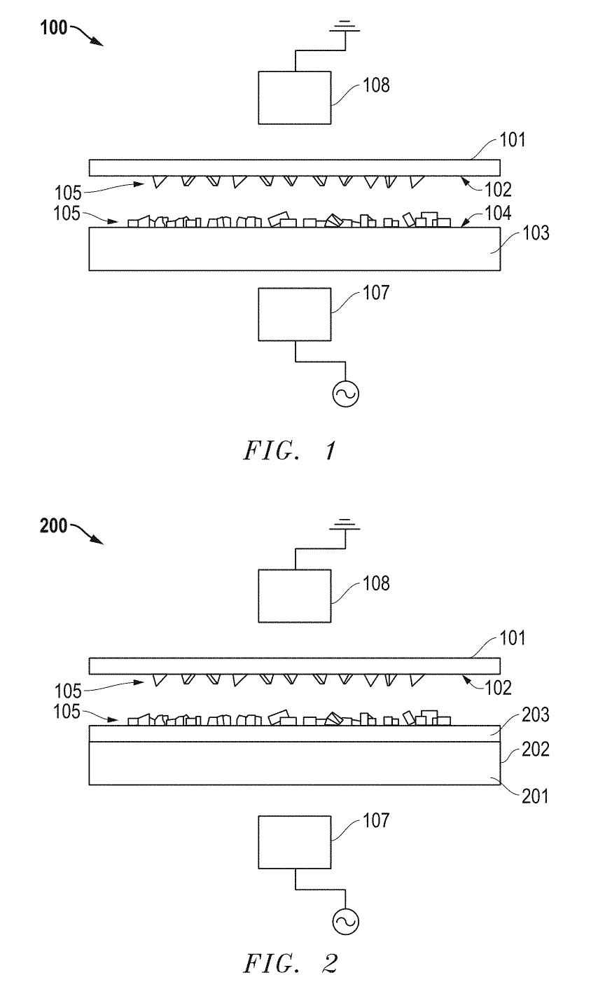

FIG. 2 includes an illustration of a system for forming a coated abrasive article according to an embodiment. As shown in FIG. 2, the system 200 can include some of the same elements as noted above in the system 100 of FIG. 1, including a backing 101 having a receiving surface 102, a first electrode 107, and a second electrode 108. It will be appreciated that the system 200 of FIG. 2 may have any of the characteristics described herein with respect to the system 100 of FIG. 1. As further illustrated, the substrate 202 can include multiple portions, including a first portion 201 and a second portion 203. In one embodiment as illustrated in FIG. 2, the second portion 203 can be in the form of a layer overlying the first portion 201. The second portion 203 may be a film or laminate in direct contact with the first portion 201. Still, in other instances, the second portion 203 can be made of a series of films or layers, such as a composite material made up of a series of different layers of material. Likewise, in at least one embodiment, the first portion 201 can be made of a series of films or layers of materials, including a composite material having multiple different layers of material.

It will be appreciated that other arrangements of the first portion 201 and second portion 203 can be utilized. For example, in one embodiment, the second portion 203 can define a discontinuous layer of discrete regions on an upper surface of the first portion 201. Notably, in one embodiment, the particles 105 can be in direct contact with the second portion 203, and can be spaced apart from the first portion 201. Moreover, in one aspect, the first portion 201 is disposed between the second portion 203 and the first electrode 107. In still another alternative arrangement, the first portion 201 and second portion 203 can include openings, which may facilitate holding abrasive particles therein and/or the application of a differential pressure between opposing surfaces of the substrate 202 to facilitate controlled placement of the abrasive particles in the openings.

In one embodiment, the first portion 201 can have a particular bulk resistivity relative to the second portion 203. The difference in bulk resistivity between the first and second portions 201 and 203 may facilitate improved projection of the particles (e.g., abrasive particles 105) onto the backing 101 and improved orientation of the particles (e.g., abrasive particles) on the backing 101. According to one aspect, the second portion 203 can have a bulk resistivity less than a bulk resistivity of the first portion 201. In at least one embodiment, the substrate 202 can have a bulk resistivity difference (Δr=absolute value of (r2/r1)×100) of at least 1% between the bulk resistivity of the first portion 201 (r1) and the bulk resistivity of the second portion 203 (r2). In another embodiment the bulk resistivity difference (Δr) can be at least 2%, such as at least 3% or at least 4% or at least 5% or at least 6% or at least 7% or at least 8% or at least 9% or at least 10% or at least 15% or at least 20% or least 25% or at least 30% or at least 35% or at least 40% or at least 45% or at least 50% or at least 55% or at least 60% or at least 65% or at least 70% or least 75% or at least 80% or at least 85% or at least 90% or at least 95%. In another non-limiting embodiment, the bulk resistivity difference (Δr) can be not greater than 99%, such as not greater than 90% or not greater than 80% or not greater than 70% or not greater than 60% or not greater than 50% or not greater than 40% or not greater than 30% or not greater than 20% or not greater than 10% or not greater than 30%. It will be appreciated that the bulk resistivity difference can be within a range including any of the minimum and maximum percentages noted above, including but not limited to at least 1% and not greater than 99% or within a range of at least 1% and not greater than 50% or within a range of at least 10% and not greater than 90% or within a range of at least 20% and not greater than 50%.

According to one embodiment, the first portion 201 can have a bulk resistivity similar to that of the substrate 103 described herein. For example, the first portion can have a bulk resistivity of not less than 1E-6 Ωcm, such as not less than 1E-5 Ωcm or not less than 1E-4 Ωcm or not less than 1E-3 Ωcm or not less than 1E-2 Ωcm or not less than 1E-1 Ωcm or not less than 1 Ωcm or not less than 1E+1 Ωcm or not less than 1E+2 Ωcm or not less than 1E+3 Ωcm or not less than 1E+4 Ωcm or not less than 1E+5 Ωcm or not less than 1E+6 Ωcm or not less than 1E+7 Ωcm or not less than 1E+8 Ωcm or not less than 1E+9 Ωcm or not less than 1E+10 Ωcm. Still, in one non-limiting embodiment, the bulk resistivity of the first portion 201 can be not greater than 1E+14 Ωcm or not greater than 1E+13 Ωcm or not greater than 1E+12 Ωcm or not greater than 1E+11 Ωcm or not greater than 1E+10 Ωcm or not greater than 1E+9 Ωcm or not greater than 1E+8 Ωcm or not greater than 1E+7 Ωcm or not greater than 1E+6 Ωcm or not greater than 1E+5 Ωcm or not greater than 1E+4 Ωcm or not greater than 1E+3 Ωcm or not greater than 1E+2 Ωcm or not greater than 1E+1 Ωcm or not greater than 1 Ωcm or not greater than 1E-1 Ωcm or not greater than 1E-2 Ωcm or not greater than 1E-3 Ωcm or not greater than 1E-4 Ωcm or not greater than 1E-5 Ωcm. It will be appreciated that the bulk resistivity of the first portion can be within a range including any of the minimum and maximum values noted above.

In a further aspect, the second portion 203 can have a particular bulk resistivity that may facilitate suitable operation of the system and formation of certain coated abrasive articles. For example, the second portion 203 can have a bulk resistivity of not less than 1E-6 Ωcm, such as not less than 1E-5 Ωcm or not less than 1E-4 Ωcm or not less than 1E-3 Ωcm or not less than 1E-2 Ωcm or not less than 1E-1 Ωcm or not less than 1 Ωcm or not less than 1E+1 Ωcm or not less than 1E+2 Ωcm or not less than 1E+3 Ωcm or not less than 1E+4 Ωcm or not less than 1E+5 Ωcm or not less than 1E+6 Ωcm or not less than 1E+7 Ωcm or not less than 1E+8 Ωcm or not less than 1E+9 Ωcm. Still, in one non-limiting embodiment, the bulk resistivity of the second portion can be not greater than 1E+10 Ωcm, such as not greater than 1E+9 Ωcm or not greater than 1E+8 Ωcm or not greater than 1E+7 Ωcm or not greater than 1E+6 Ωcm or not greater than 1E+5 Ωcm or not greater than 1E+4 Ωcm or not greater than 1E+3 Ωcm or not greater than 1E+2 Ωcm or not greater than 1E+1 Ωcm or not greater than 1 Ωcm or not greater than 1E-1 Ωcm or not greater than 1E-2 Ωcm or not greater than 1E-3 Ωcm or not greater than 1E-4 Ωcm or not greater than 1E-5 Ωcm. It will be appreciated that the bulk resistivity of the second portion can be within a range including any of the minimum and maximum values noted above.

According to one embodiment, the substrate 202 can have a resistivity ratio (Sr/Br) that is the same as any of the resistivity ratio values noted in the other embodiments herein. In another embodiment, the first and second portions 201 and 203 of the substrate 202 may have a particular bulk resistivity and/or surface resistivity that may facilitate improved projection of the abrasive particles and may further facilitate improved placement and/or orientation of the abrasive particles on the backing 101. In particular, relationship of the bulk resistivity and/or surface resistivity of the first and second portions 201 and 203 relative to each other may facilitate improved projection of the abrasive particles and may further facilitate improved placement and/or orientation of the abrasive particles on the backing 101.

In one embodiment, the first portion 201 can have a bulk resistivity (Br1) and the second portion 203 can have a surface resistivity (Sr2), and the substrate can have a surface-to-bulk resistivity (Sr2/Br1) that is at least 0.5 cm⁻¹, such as at least 0.6 cm⁻¹ or at least 0.7 cm⁻¹ or at least 0.8 cm⁻¹ or at least 0.9 cm⁻¹ or at least 1 cm⁻¹ or at least 1.1 cm⁻¹ or at least 1.2 cm⁻¹ or at least 1.3 cm⁻¹ or at least 1.5 cm⁻¹ or at least 1.7 cm⁻¹ or at least 2 cm⁻¹ or at least 3 cm⁻¹ or at least 4 cm⁻¹ or at least 5 cm⁻¹. Still, in at least one embodiment, the resistivity ratio (Sr/Br) of the substrate 103 can be not greater than 1E+5 cm⁻¹ or not greater than 1E+4 cm⁻¹ or not greater than 1E+3 cm⁻¹ or not greater than 1E+2 cm⁻¹ or not greater than 1E+1 cm⁻¹ or not greater than 9 cm⁻¹ or not greater than 8 cm⁻¹ or not greater than 7 cm⁻¹ or not greater than 5 cm⁻¹ or not greater than 3 cm⁻¹. It will be appreciated that the surface-to-bulk resistivity (Sr2/Br1) can be within a range including any of the minimum and maximum values noted above.

According to one embodiment, the abrasive particles 105 can be projected using an alternating frequency electric field. The use of alternating frequency may facilitate improved control of the process and facilitate formation of particular coated abrasive articles. For example, the frequency of the electric field can be at least 0.5 Hz, such as at least 1 Hz or at least 2 Hz or at least 3 Hz or at least 4 Hz or at least 5 Hz or at least 6 Hz or at least 7 Hz or at least 8 Hz or at least 9 Hz or at least 10 Hz or at least 11 Hz or at least 12 Hz or at least 13 Hz or at least 14 Hz or at least 15 Hz or at least 16 Hz or at least 17 Hz or at least 18 Hz or at least 19 Hz or at least 20 Hz or at least 21 Hz or at least 22 Hz or at least 23 Hz or at least 24 Hz or at least 25 Hz or at least 26 Hz or at least 27 Hz or at least 28 Hz or at least 29 Hz or at least 30 Hz at least 31 Hz or at least 32 Hz or at least 33 Hz or at least 34 Hz or at least 35 Hz or at least 36 Hz or at least 37 Hz or at least 38 Hz or at least 39 Hz. Still, in one non-limiting embodiment, the frequency of the electric field can be not greater than 40 Hz or not greater than 39 Hz or not greater than 38 Hz or not greater than 37 Hz or not greater than 36 Hz or not greater than 35 Hz or not greater than 34 Hz or not greater than 33 Hz or not greater than 32 Hz or not greater than 31 Hz or not greater than 30 Hz or not greater than 29 Hz or not greater than 28 Hz or not greater than 27 Hz or not greater than 26 Hz or not greater than 25 Hz or not greater than 24 Hz or not greater than 23 Hz or not greater than 22 Hz or not greater than 21 Hz or not greater than 20 Hz or not greater than 19 Hz or not greater than 18 Hz or not greater than 17 Hz or not greater than 16 Hz or not greater than 15 Hz or not greater than 14 Hz or not greater than 13 Hz or not greater than 12 Hz or not greater than 11 Hz or not greater than 10 Hz or not greater than 9 Hz or not greater than 8 Hz or not greater than 7 Hz or not greater than 6 Hz or not greater than 5 Hz or not greater than 4 Hz or not greater than 3 Hz or not greater than 2 Hz or not greater than 1 Hz. It will be appreciated that the frequency of the electric field can be within a range including any of the minimum and maximum values noted above. It will be appreciated that any of the embodiments herein may utilize an alternating electric field to facilitate projection of the particles from the substrate 103 to the backing 101.

According to one aspect, the present system is suitable for use with alternating currents (AC), wherein the polarity of the field changes over a certain time and the change in polarity assists with the projection of the particles. Certain aspects of the system and embodiments herein may be less suitable for use in a direct current (DC) system, which may allow for charge accumulation and result in lower projection efficiency and control of the projection operation.

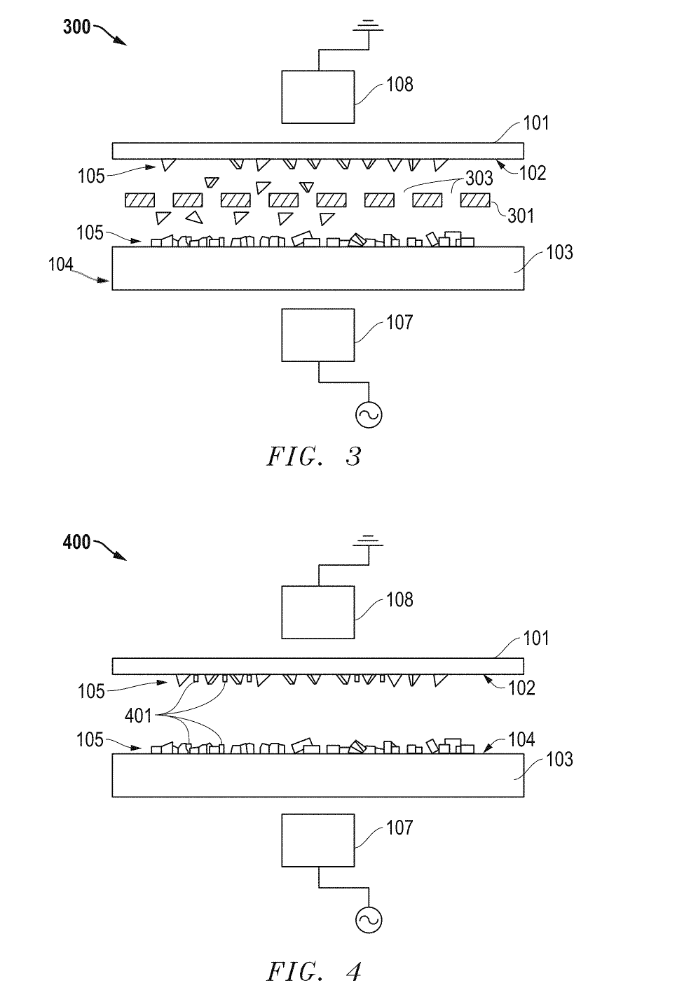

FIG. 3 includes an illustration of a system used for forming a coated abrasive article according to an embodiment. As shown in FIG. 3, the system 300 can include some of the same elements of the system 100 of FIG. 1, including for example, a backing 101 having a receiving surface 102, a substrate 103 and substrate receiving surface 104, abrasive particles 105 configured to be contained on the receiving surface 104, a first electrode 107 and a second electrode 108. The elements of the system 300 can have any of the same features as corresponding elements in other systems described in the embodiments herein. Moreover, the system 300 can have any of the same features (e.g., projection efficiency, etc.) as described in other embodiments herein. The abrasive particles 105 can be contained on the receiving surface 104 of the substrate 103 and configured to be projected vertically onto the receiving surface 102 of the backing in the presence of an electrical field created by the electrodes 107 and 108.

The system 300 can further include an alignment structure 301 disposed between the substrate 103 and the backing 101. The alignment structure 301 can be disposed within the gap between the substrate 103 and the backing 101. It will be appreciated that in other embodiments the alignment structure 301 can be disposed closer to the backing 101 or the substrate 103. In one embodiment, at least a portion of the alignment structure 301 can be in contact with at least a portion of the backing 101, and more particularly, at least a portion of the receiving surface 102 of the backing. The alignment structure 301 can include openings 303 that can be positioned, sized, and shaped to facilitate the controlled passage of particles 105 therethrough. The size, shape, and location of the openings 303 relative to the backing 101 can be configured to control the placement and orientation of the abrasive particles 105 as they are projected from the receiving surface 104 of the substrate 103 to the receiving surface 102 of the backing 101.

In one aspect, during operation of the system 300, the first electrode 107 and the second electrode 108 can create an electrostatic force configured to facilitate projection of the abrasive particles 105 vertically across the gap from the substrate 103, through the openings 303 in the alignment structure 301 and onto the backing 101. The size, shape, and position of the openings 303 of the alignment structure 301 can be modified based on the size and shape of the abrasive particles 105 and the desired distribution of the abrasive particles on the backing 101. In one particular embodiment, the abrasive particles 105 can be projected through openings 303 in the alignment structure 301 to control at least one of a rotational orientation and position of the abrasive particles on the backing. The alignment structure may be made of any material, including but not limited to an organic material, a metal, metal alloy, ceramic, glass, or any combination thereof.

FIG. 4 includes an illustration of an example system 400 for forming a coated abrasive article according to an embodiment. As shown in FIG. 4, a system 400 for forming a coated abrasive article. The system 400 As shown in FIG. 3, the system 300 can include some of the same elements of the system 100 of FIG. 1, including for example, a backing 101 having a receiving surface 102, a substrate 103 and substrate receiving surface 104, abrasive particles 105 configured to be contained on the receiving surface 104, a first electrode 107 and a second electrode 108. The elements of the system 400 can have any of the same features as corresponding elements in other systems described in the embodiments herein.

The system 400 can further include secondary particles 401, which can be distinct from the abrasive particles 105. In one particular embodiment, the secondary particles 401 can be distinct from the abrasive particles 105 based on at least one characteristic selected from the group consisting of particle size, two-dimensional shape, three-dimensional shape, composition, hardness, toughness, friability, density, grain size, agglomeration state, or any combination thereof. In one particular embodiment, the secondary particles can include diluent abrasive particles. The diluent particles can have a different composition or be cheaper relative to the abrasive particles 105. In one embodiment, the diluent particles can have a hardness less than the hardness of the abrasive particles. In another embodiment, the diluent particles can have a hardness greater than the hardness of the abrasive particles 105.

The secondary particles 401 can be projected in the same manner as the abrasive particles 105 as described in embodiments herein. Notably, the secondary particles 401 can be projected from the substrate receiving surface 104 vertically onto the receiving surface 102 of the backing 101. In one embodiment, that the secondary particles 401 can be projected simultaneously with the abrasive particles 105 onto the backing 101. In another aspect, the secondary particles 401 can be projected onto the backing 101 separate from the abrasive particles 105, such as before the abrasive particles 105 are projected or after the abrasive particles 105 are projected.

In at least one embodiment, the secondary particles 401 can have an aspect ratio of length:width, wherein the length is the longest average dimension of the particles and the width is the second longest average dimension of the particles extending perpendicular to the length and within the same plane as the length. The secondary particles 401 can be projected in a particular manner such that the placement, orientation, and/or distribution of the secondary particles 401 on the backing 101 is controlled. It will be appreciated that the process of projecting the secondary particles 401 can be used in any of the systems described in the embodiments herein.

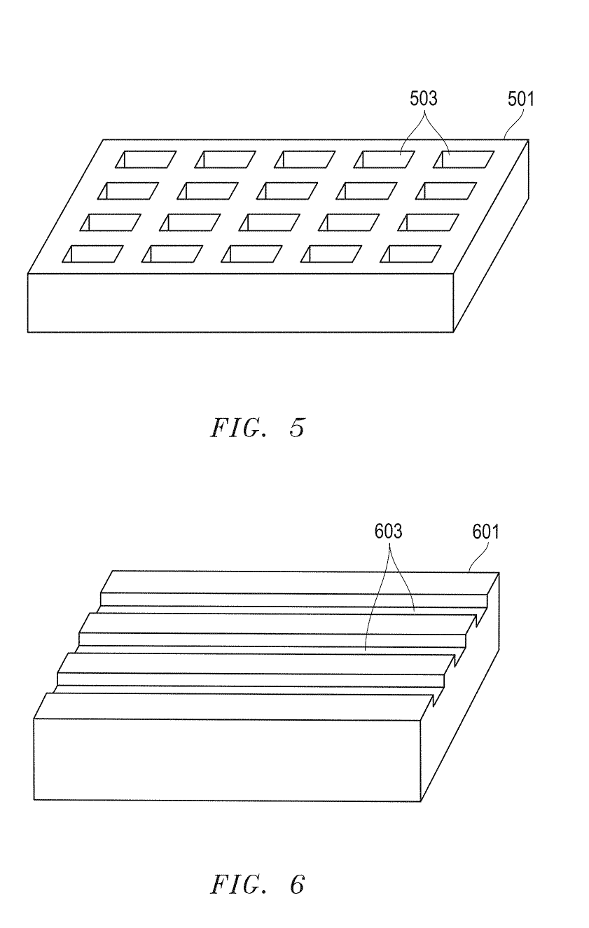

FIG. 5 includes an illustration of a containment region 501 according to an embodiment. In one embodiment, the substrate 101 can include a containment region 501. The containment region 501 can define a portion of the substrate receiving surface 104 and may be configured to contain one or more particles (e.g., abrasive particles and/or secondary particles) within one or more openings 503. For example as illustrated, the containment region 501 can include at least one opening 503 in the substrate 103 and at least one abrasive particle 105 can be at least partially disposed within the at least one opening 503. The size and shape of the openings 503 can be adapted based on the size and shape of the particles to be contained therein. Each of the openings 503 may be sized and shaped to contain a single particle. The placement of the openings 503 may also be controlled to control the distribution of the particles on the backing 101. The containment region 501 can be configured to control the placement and orientation of the particles as they are projected onto the backing. The particles can be projected from the controlled location and orientations of the containment region 501 onto the backing and create a coated abrasive article having particles arranged in the controlled location and orientation substantially corresponding to the controlled location and orientation of the particles as they were held in the containment region 501.

In one aspect, the process of using the containment region can include projecting the particles (e.g., abrasive particles 105 and/or secondary particles 401) from the containment region 501 onto the backing 101 with a controlled position. In a further aspect, the particles projected from the containment region 501 can be attached to the backing 101 with a controlled rotational orientation.

The containment region 501 may be used with any substrate of the embodiments herein, including substrates including multiple portions, such as illustrated in the system 200. In one particular instance, the containment region 501 can be the substrate, and thus the containment region 501 can have any of the features of any of the substrates described in embodiments herein. In one embodiment, the containment region 501 can have different portions, wherein the portions (e.g., the openings 503) are configured to contain the particles can define a second portion and the remainder of the containment region 501 can define a first portion. The portions can have any of the features of the portions described in accordance with the substrate 202 of FIG. 2. For example, the containment region 503 can include at least one of a depression, an opening, a conductive region, or a combination thereof.

Alternatively or additionally, a containment region 501 can have openings that extend partially or entirely through the thickness of the body of the containment region 501. For those embodiments using openings extending entirely through the thickness of the body, a differential pressure may be applied to a surface to facilitate placement of the particles in the openings. For example, a negative pressure may be applied to one surface while particles are being applied to an opposite surface to urge the particles into the openings. The differential pressure can be decreased or eliminated during projection of the particles from the containment region 501.

FIG. 6 includes an illustration of a containment region according to another embodiment. The containment region 600 can have any of the features of the containment region 500. The containment region 600 includes depression 603 that can extend along a portion of the upper surface of the containment region 600 and are configured to contain a plurality of particles (e.g., abrasive particles and/or secondary particles). The size and shape of the depressions 603 can be adapted based on the size and shape of the particles to be contained therein. Each of the depressions 603 may be sized and shaped to contain a plurality of particles. Moreover, each of the depressions 603 may be size and shaped to contain only a particular type of particle, such that for example, a first type of depression is configured to contain the abrasive particles and the second type of depression is configured to contain the secondary particles. While the depressions 603 are illustrated as being generally linear, parallel grooves, it will be appreciated that any combination of size and shape of depressions may be used to contain the particles temporarily on the containment region 600 prior to projection.

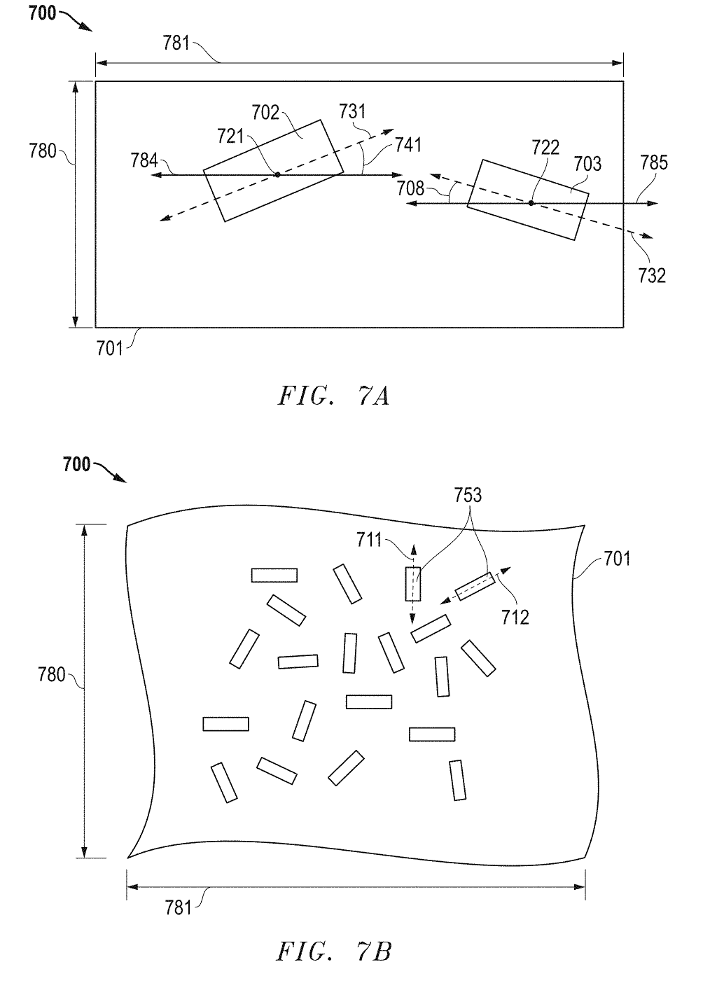

FIG. 7A includes an illustration of a portion of a coated abrasive article 700 according to an embodiment. As shown in FIG. 7, the coated abrasive article 700 can include a backing 701 having a longitudinal axis 780 and a lateral axis 781. The abrasive article 700 can include a backing 701 and abrasive particles 702 and 703 having a random rotational orientation relative to each other. FIG. 7B also includes an illustration of a portion of a coated abrasive with abrasive particles having a random rotational orientation with respect to each other. It will be appreciated that the surface of the backing 701 may include one or more adhesive layers to facilitate bonding of the abrasive particles 702 and 703 to the backing 701.

The randomness of the rotational orientation is evaluated by creating a histogram or distribution of measured orientations from randomly sampled areas from a given abrasive article. The process for measuring the rotational orientation of particles on a substrate is started by obtaining a coated abrasive sample that does not include overlying layers on the particles or cleaning the coated abrasive sample to expose the particles, such that the particles are clearly visible. If a coated abrasive article includes layers overlying the particles (e.g., size coat, supersize coat, etc.) a gentle sandblasting operation can be conducted to selectively remove the overlying layers and expose the underlying abrasive particles. Care should be taken during the sandblasting operation to ensure that the particles are not damaged or moved. The selective removal operation may be conducted in stages to ensure that only the overlying layers are removed but the underlying particles are not damaged or altered.

After obtaining a sample with the particles exposed, at least two randomly selected regions of the sample are imaged using a suitable device, such as a Cannon Powershot S110 camera with a resolution of 338 pixels/cm. From these images the location and orientation of each particle relative to the edge of the sample is cataloged using MATLAB image analysis software. The orientation of the particle is based on the angle of the major axis of the abrasive particles as viewed top-down relative to an edge (e.g., axis 780 of FIG. 7A) of the coated abrasive. The same axis should be used to evaluate all sample images. The orientation of each particle is defined by an orientation angle between −90 degrees and +90 degrees. The orientation angles are then plotted in a plot of orientation angle (x-axis) versus frequency (y-axis) to create a histogram of the orientation angles. If the histogram has an essentially flat profile, such that the frequency for any given orientation angle is nearly the same as the frequency for any other orientation angle, the histogram demonstrates that the particles generally have no primary orientation mode, and therefore, the particles have a random orientation. FIG. 19 includes an image of a portion of an abrasive article having abrasive particles in a random orientation.

It should be noted that while certain embodiments herein can have particles arranged in a random orientation, other embodiments may include particles arranged in a non-random or controlled distribution.

According to one embodiment, the abrasive particle 702 can be overlying the backing 701 in a first position having a first rotational orientation relative to a lateral axis 781 defining the width of the backing 701 and perpendicular to a longitudinal axis 780. In particular, the abrasive particle 702 can have a predetermined rotational orientation defined by a first rotational angle between a lateral axis 784 parallel to the lateral axis 781 and a dimension of the abrasive particle 702. Notably, reference herein to a dimension can be reference to a bisecting axis 731 of the abrasive particle 702 extending through a center point 721 of the abrasive particle 702 as viewed top-down. Moreover, the predetermined rotational orientation can be defined as the smallest angle 741 with the lateral axis 784 extending through the center point 721. As illustrated in FIG. 7A, the abrasive particle 702 can have a predetermined rotational angle defined as the smallest angle 741 between the bisecting axis 731 and the lateral axis 784, wherein the lateral axis is parallel to the lateral axis 781. It will be appreciated that the lateral axis 781 may also be a radial axis where the backing 701 has a circular or elliptical shape. In accordance with an embodiment, the angle 741 defining the rotational orientation of the abrasive particle 702 relative to the lateral axis 784 can be any value within a range between at least 0 degrees and not greater than 90 degrees.

As further illustrated in FIG. 7A, the abrasive particle 703 can be at a second position overlying the backing 701 and having a predetermined rotational orientation. Notably, the predetermined rotational orientation of the abrasive particle 703 can be characterized as the smallest angle between the lateral axis 785 parallel to the lateral axis 781 of the backing and a bisecting axis 732 of the abrasive particle 703 extending through a center point 722 of the abrasive particle 703. In accordance with an embodiment, the rotational angle 708 can be any value within a range of at least 0 degrees to 90 degrees.

In accordance with an embodiment, the abrasive particle 702 can have a predetermined rotational orientation as defined by the rotational angle 741 that is different than the predetermined rotational orientation of the abrasive particle 703 as defined by the rotational angle 708. In particular, the difference between the rotational angle 741 and rotational angle 708 for the abrasive particles 702 and 703 can define a predetermined rotational orientation difference. In particular instances, the predetermined rotational orientation difference can be any value within a range of at least 0 degrees and not greater than 90 degrees.

FIG. 7B includes a top-view illustration of a portion of a coated abrasive article according to an embodiment. As illustrated, the abrasive article 700 can include a plurality of abrasive particles arranged at different positions on the backing 701, wherein the abrasive particles 753 define a random distribution of the particles on the backing. Moreover, the abrasive particles 753 have a random rotational orientation with respect to each other, such that the rotational orientation of the abrasive particles 753 varies from particle-to-particle in a random manner. According to one aspect, the random rotational orientation of the abrasive particles is such that the rotational angle of one abrasive particle in the group cannot be used to predict the rotational orientation of any of the immediately adjacent particles. Thus, a group of abrasive particles having a random rotational orientation lack any short range (i.e., immediately adjacent) or long range order with respect to their rotational angles. It will be appreciated that any particles attached to the backing using the systems and processes of the embodiments herein can have a random rotational orientation with respect to each other.

The coated abrasive articles of the embodiments herein can have at least a majority of the total content (weight or number) of abrasive particles having a random rotational orientation on the backing. In still other instances, the total content of abrasive particles on the backing having a random rotational orientation can be greater, such as at least 60% or at least 70% or at least 80% or at least 90% or at least 99% of the abrasive particles on the backing can have a random rotational orientation. In one embodiment, all of the abrasive particles on the backing have a random rotational orientation.

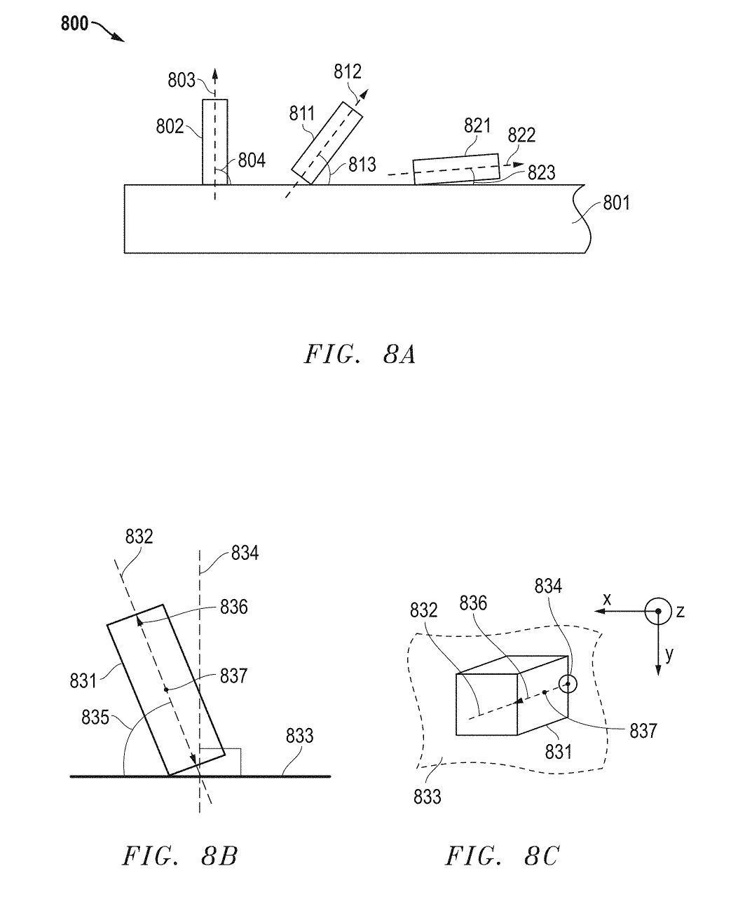

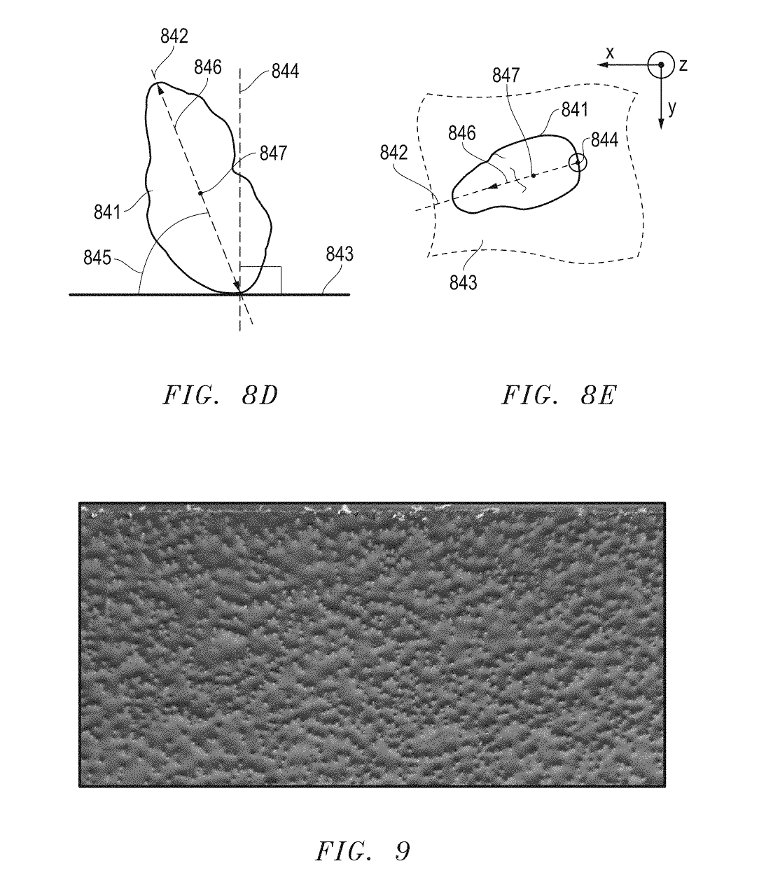

FIG. 8A includes a side-view illustration of abrasive particles on a backing according to an embodiment. The methods disclosed in the embodiments herein can facilitate the formation of coated abrasive articles having a particular distribution and orientation of abrasive particles. Notably, without wishing to be tied to a particular theory, it is noted that the projection rate and efficiency of the process disclosed herein may facilitate improved control of the tilt angle of the abrasive particles adhered to the backing. For example, in one aspect, the coated abrasive articles of the embodiments herein can have at least 87% of the abrasive particles oriented at a tilt angle within a range of greater than 44 degrees to 90 degrees, and not greater than 13% of the abrasive particles can be oriented at a tilt angle of not greater than 44 degrees. In still another aspect, the coated abrasive can be formed such that a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and a third portion (P3) of the abrasive particles have a flat orientation having a tilt angle within a range of 0 degrees to 44 degrees, and the abrasive particles can have a primary orientation value (P1/P2) of at least 2.5. And in still another aspect, the coated abrasive articles of the embodiments herein can include a first portion (P1) of the abrasive particles having an upright orientation having a tilt angle within a range of greater than 71 degrees to 90 degrees, a second portion (P2) of the abrasive particles having a slanted orientation having a tilt angle within a range of greater than 44 degrees to 71 degrees, and a third portion (P3) of the abrasive particles having a flat orientation having a tilt angle within a range of 0 degrees to 44 degrees, wherein the abrasive particles have a tertiary orientation value (P1/P3) of at least 4.0.

To better understand these features, FIG. 8A provides a side-view illustration of three abrasive particles in various orientations. It will be appreciated that the coated abrasive articles of the embodiments herein can have various contents of particles in the depicted orientations as described in more detail herein. The first particle 802 can have a particle axis 803 extending at a particular tilt angle 804 relative to the surface of the backing 801. The particle axis 803 can be parallel to the longitudinal axis of the first particle 802 that defines the length of the first particle 802. The first particle 802 is representative of a particle in an upright orientation having a tilt angle 804 within a range of greater than 71 degrees to 90 degrees. The second particle 811 can have a particle axis 812 extending at a particular tilt angle 813 relative to the surface of the backing 801. The particle axis 812 can be parallel to a longitudinal axis of the second particle 811 that defines the length of the second particle 811. The second particle 811 is representative of a particle in a slanted orientation having a tilt angle 813 within a range of greater than 44 degrees to 71 degrees. The third particle 821 can have a particle axis 822 extending at a particular tilt angle 823 relative to the surface of the backing 801. The particle axis 822 can be parallel to a longitudinal axis of the third particle 821 that defines the length of the third particle 821. The third particle 821 is representative of a particle in a flat orientation having a tilt angle 823 within a range of 0 degrees to not greater than 44 degrees (i.e., not greater than 44 degrees). It will be appreciated that the first, second and third particles 802, 811 and 821, respectively, can be abrasive particles or secondary particles as described in the embodiments herein.

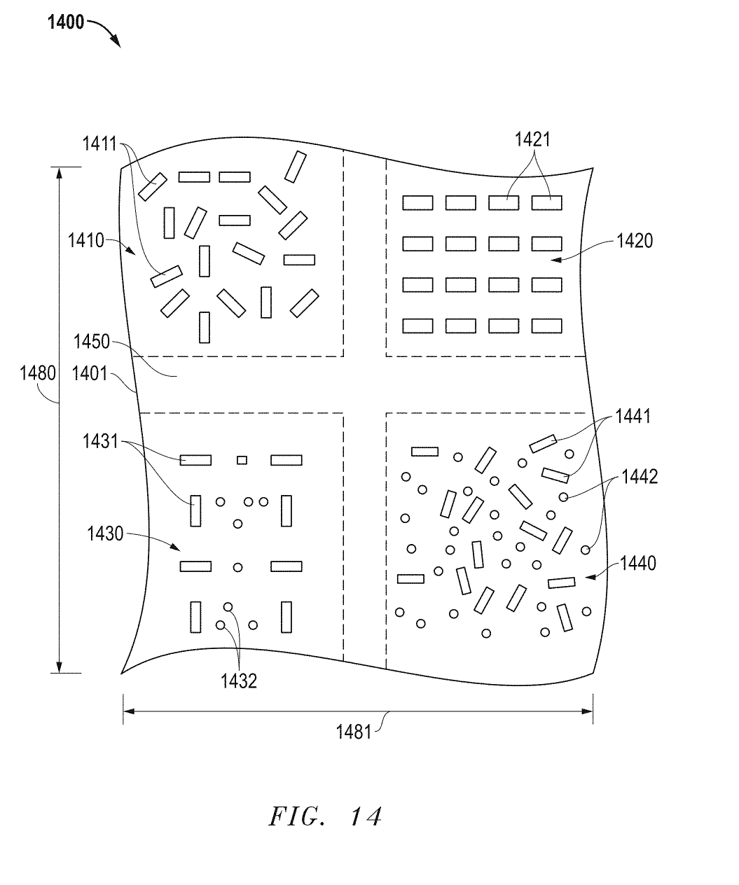

FIG. 8B includes a side-view illustration of a particle on a backing having a particular tilt angle according to an embodiment. As illustrated, the particle 831 can be a shaped abrasive particle as described in embodiments herein and having a generally elongated, rectangular shape similar to the shaped abrasive particle of FIG. 11. The particle 831 can have a longitudinal axis 836 as described in the embodiment of FIG. 11. The backing 833 can define a substantially planar surface and have an axis 834 extending normal to the substantially planar surface of the backing 833. The tilt angle 835 is the smallest angle between the planar surface of the backing 833 and an axis 832, which extends parallel to the longitudinal axis 836 of the particle 831. Certain particles can have longitudinal axes along various surfaces, which may results in different tilt angles. In such instances, the axis defining the largest angle is the tilt angle.

FIG. 8C includes a top-down illustration of the particle of FIG. 8B. In certain instances, a top-down view may provide a suitable vantage for identifying the direction of the tilt and thus can be suitable for measuring the tilt angle.

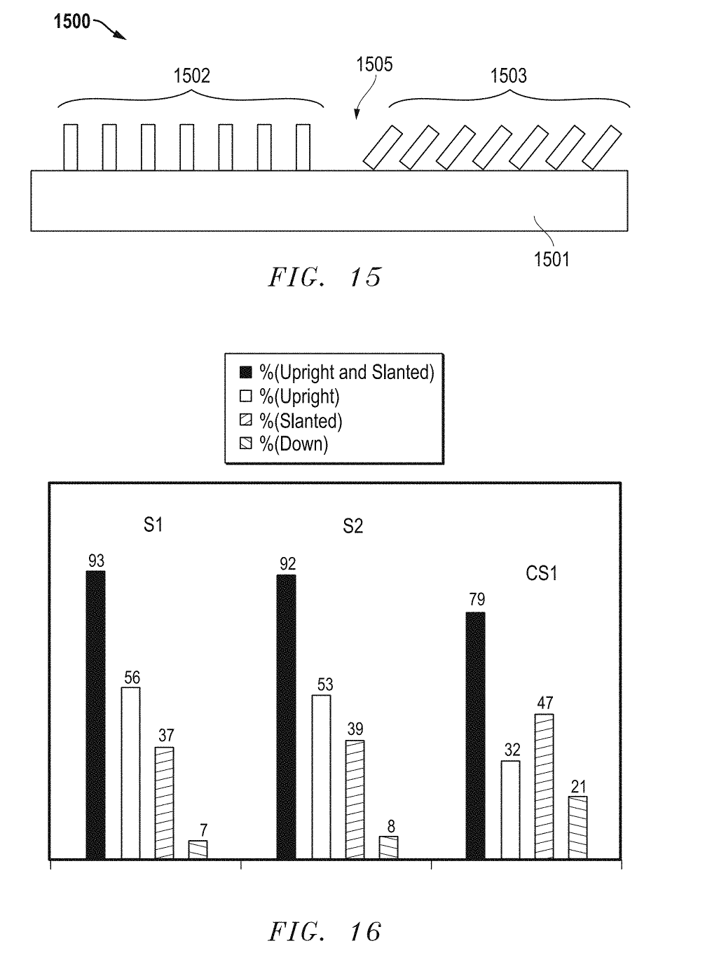

FIG. 8D includes a side-view illustration of a particle on a backing having a particular tilt angle according to an embodiment. As illustrated, the particle 841 can have a longitudinal axis 846 as described in FIG. 12B. The particle 841 can be an abrasive particle, and more particularly, can be a non-shaped abrasive particle. The backing 843 can define a substantially planar surface and have an axis 844 extending normal to the substantially planar surface of the backing 843. The tilt angle 845 can be the smallest angle between an axis 842, which extends parallel to the longitudinal axis 846 and the surface of the backing 843. The particle 841 can have a particular aspect ratio greater than 1.1:1 based on the length:width of the body. It will be appreciated that certain particles, such as equiaxed particles, will not have a tilt angle.

FIG. 8E includes a top-down illustration of the particle of FIG. 8D. The top down view may be used to evaluate the tilt angle of the particle. As depicted, the top-down view may be the best view for evaluating the tilt angle as a side-view may not necessarily ensure the smallest angle is identified. A combination of top-down and side-view illustrations may be suitable for identifying and evaluating the tilt angle 845.

In one aspect, a coated abrasive article may include a plurality of abrasive particles, wherein the tilt angle of the abrasive particles is controlled, which may facilitate improved performance of the coated abrasive. For example, at least 87% of the abrasive particles can be oriented at a tilt angle within a range of greater than 44 degrees to 90 degrees (i.e., those particles having a slanted orientation and upright orientation). In further aspects, at least 88% of the abrasive particles can be oriented at a tilt angle within a range of greater than 44 degrees to 90 degrees, such as at least 89% or at least 90% or at least 91% or at least 92% or at least 93% or at least 94% or at least 95% or at least 96% or at least 97% or at least 98% or at least 99%. Still, in one non-limiting embodiment, not greater than 99% of the abrasive particles can be oriented at a tilt angle of greater than 44 degrees to 90 degrees, such as not greater than 98% or not greater than 97%. It will be appreciated that the coated abrasive can have a content of abrasive particles oriented at a tilt angle of greater than 44 degrees to 90 degrees within a range of any of the minimum and maximum percentages noted above, including for example, within a range of at least 87% to 99% or within a range of at least 90% to not greater than 99% or even within a range of at least 93% and not greater than 99%.

In other aspects, the coated abrasive article may be formed to include a plurality of abrasive particles having a small content of abrasive particles in a flat orientation, which may facilitate improved performance of the coated abrasive. For example, a representative coated abrasive article may have not greater than 13% of the abrasive particles oriented at a tilt angle of not greater than 44 degrees, such as not greater than 12% or not greater than 11% or not greater than 10% or not greater than 9% or not greater than 8% or not greater than 7% or not greater than 6% or not greater than 5% or not greater than 4% or not greater than 3% or not greater than 2% or even not greater than 1% of the abrasive particles oriented at a tilt angle of not greater than 44 degrees. In one non-limiting embodiment, at least 1% of the abrasive particles can be oriented at a tilt angle of not greater than 44 degrees, such as at least 2% or at least 3% or at least 4% or at least 5%. It will be appreciated that the coated abrasive can have a particular content of abrasive particles oriented in a flat orientation and having a tilt angle of not greater than 44 degrees, and such a content can be within a range of any of the minimum and maximum percentages noted above, including for example, within a range of at least 1% and not greater than 13% or within a range of at least 1% to not greater than 10% or even within a range of at least 1% and not greater than 8%.

In yet another aspect, a representative coated abrasive article may be formed to include a plurality of abrasive particles having a certain content of abrasive particles in a slanted orientation having a tilt angle within a range of greater than 44 degrees to 71 degrees, which may facilitate improved performance of the coated abrasive. For example, in one embodiment, the coated abrasive article may have not greater than 25% of the abrasive particles oriented at a tilt angle within a range of greater than 44 degrees to 71 degrees, such as not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 5% or not greater than 2%. In one non-limiting embodiment, at least 1% of the abrasive particles can be oriented at a tilt angle of greater than 44 degrees to 71 degrees, such as at least 2% or at least 3% or at least 4% or at least 5% or at least 8% or at least 10% of the abrasive particles. It will be appreciated that the coated abrasive can have a particular content of abrasive particles oriented in a slanted orientation and having a tilt angle within a range of greater than 44 degrees to 71 degrees, and such a content can be within a range of any of the minimum and maximum percentages noted above, including for example, within a range of at least 1% and not greater than 25% or within a range of at least 1% to not greater than 20% or even within a range of at least 1% and not greater than 12%.

According to another embodiment, the coated abrasive article may include a plurality of abrasive particles having a certain content of abrasive particles in an upright orientation having a tilt angle within a range of greater than 71 degrees to 90 degrees, which may facilitate improved performance of the coated abrasive. For example, in one embodiment, the coated abrasive article may have at least 60% of the abrasive particles oriented at a tilt angle of greater than 71 degrees to 90 degrees, such as at least 62% or at least 65% or at least 67% or at least 70% or at least 72% or at least 75% or at least 77% or at least 80% or at least 82% or at least 85% or at least 87% or at least 90% or at least 92% or at least 95% or at least 97% of the abrasive particles having a tilt angle of greater than 71 degrees to 90 degrees. In one non-limiting embodiment, the number of particles having an upright orientation may be limited, such as not greater than 99% or not greater than 98% or not greater than 97% or even not greater than 95% of the abrasive particles having a tilt angle within a range of greater than 71 degrees to 90 degrees. It will be appreciated that the percentage of abrasive particles having an upright orientation with a tilt angle within a range of greater than 71 degrees to 90 degrees can be within a range of any of the minimum and maximum percentages noted above, including for example, within a range of at least 60% and not greater than 99% or within a range of at least 65% to not greater than 99% or within a range of at least 70% and not greater than 99% or within a range including at least 82% and not greater than 99%.

As noted herein, in one embodiment, a coated abrasive article can include a plurality of abrasive particles, and the abrasive particles may include a first portion (P1) in an upright orientation having a tilt angle within a range of greater than 71 degrees to 90 degrees, a second portion (P2) in a slanted orientation having a tilt angle within a range of greater than 44 degrees to 71 degrees, and a third portion (P3) in a flat orientation having a tilt angle within a range of 0 degrees to 44 degrees. Reference herein to a coated abrasive that may include first, second and third portions is not a requirement that any one of the portions be present unless the percentage of particles is noted as being greater than 0%. Some abrasive articles of the embodiments herein may have 0% of abrasive particles in the second portion or third portion.

In one particular aspect, the abrasive particles can have a primary orientation value (P1/P2) of at least 2.5, wherein P1 represents the number of abrasive particles having an upright orientation and P2 represents the number of abrasive particles having a slanted orientation. The numbers generated for P1, P2, and P3 should be generated from at least three different random sampling regions on the coated abrasive including a sufficient sampling size to create statistically relevant data set. Further detail on how to measure the orientation are provided below. The values for P1, P2 and P3 should be averaged and the average values used to calculate the primary, secondary and tertiary orientation values as described herein. According to one embodiment, the coated abrasive can have a primary orientation value (P1/P2) of at least 2.6 or at least 2.7 or at least 2.8 or at least 2.9 or at least 3.0 or at least 3.1 or at least 3.2 or at least 3.3 or at least 3.4 or at least 3.5 or at least 3.6 or at least 5 or at least 10 or at least 20 or at least 30 or at least 40 or at least 50 or at least 60 or at least 70 or at least 80 or at least 90 or at least 99. In another non-limiting embodiment, the coated abrasive can have a primary orientation value (P1/P2) of not greater than 100, such as not greater than 90 or not greater than 80 or not greater than 70 or not greater than 50 or not greater than 30 or not greater than 20 or not greater than 10 or not greater than 9 or not greater than 8 or not greater than 7 or not greater than 6 or not greater than 5 or not greater than 4. In one non-limiting embodiment, the primary orientation value can be within a range of any of the minimum and maximum values noted herein, including for example, within a range of at least 2.5 and not greater than 100 or within a range of at least 2.7 and not greater than 20 or within a range of at least 3 and not greater than 10 or within a range of at least 3 and not greater than 7.

As noted herein, coated abrasive article can include a plurality of abrasive particles, wherein the abrasive particles have a tertiary orientation value (P1/P3) of at least 4.0. According to one embodiment, the coated abrasive can abrasive particles defining a tertiary orientation value (P1/P3) of at least 4.5 or at least 5 or at least 5.5 or at least 6 or at least 6.5 or at least 7 or at least 7.5 or at least 8 or at least 8.5 or at least 9 or at least 9.5 or at least 10 or at least 10.5 or at least 11 or at least 11.5 or at least 12 or at least 12.5 or at least 13. or at least 20 or at least 30 or at least 40 or at least 50 or at least 60 or at least 70 or at least 80 or at least 90 or at least 99. In one non-limiting embodiment, the abrasive particles can have a tertiary orientation value (P1/P3) of not greater than 100 or not greater than 90 or not greater than 80 or not greater than 70 or not greater than 60 or not greater than 50 or not greater than 40 or not greater than 30 or not greater than 20 or not greater than 18 or not greater than 15 or not greater than 14 or not greater than 13 or not greater than 12 or not greater than 11. It will be appreciated that the tertiary orientation value (P1/P3) can be within a range of any of the minimum and maximum values noted herein, including for example, within a range of at least 1.6 and not greater than 100 or within a range of at least 2 and not greater than 99 or within a range of at least 10 and not greater than 99 or within a range of at least 70 and not greater than 90.

In another aspect, the abrasive particles of the coated abrasive article can have an upright-to-slanted and down orientation value (P1/(P2+P3)) of at least 1.5. For example, the abrasive particles can have an upright-to-slanted and down orientation value (P1/(P2+P3)) of at least 1.6 or at least 1.7 or at least 1.8 or at least 1.9 or at least 2.0 or at least 2.1 or at least 2.2 or at least 2.3 or at least 2.4 or at least 2.5 or at least 2.6 or at least 2.7 or at least 2.8 or at least 2.9 or at least 3.0 or at least 3.2 or at least 3.5 or at least 3.7 or at least 4.0 or at least 4.2 or at least 4.5 or at least 4.7 or at least 5.0 or at least 5.2 or at least 5.5 or at least 5.7 or at least 6.0.7 or at least 10 or at least 20 or at least 30 or at least 40 or at least 50 or at least 60 or at least 70 or at least 80 or at least 90 or at least 99. According to one non-limiting embodiment, the coated abrasive can have an upright-to-slanted and down orientation value (P1/(P2+P3)) of not greater than 100, such as not greater than 90 or not greater than 80 or not greater than 70 or not greater than 60 or not greater than 50 or not greater than 40 or not greater than 30 or not greater than 20 or not greater than 10 or not greater than 8 or not greater than 6. It will be appreciated that the upright-to-slanted and down orientation value (P1/(P2+P3)) can be within a range including any of the minimum and maximum values noted above, including for example, within a range of at least 1.5 and not greater than 100 or within a range of at least 2 and not greater than 99 or within a range of at least 2.5 and not greater than 50 or within a range of at least 2.55 and not greater than 10.

The foregoing has mentioned various orientations of abrasive particles on the coated abrasive. It should be noted that such orientations features are equally applicable to secondary grains. Therefore, a coated abrasive article according to an embodiment can include one or more types of secondary particles having any one or more of the orientation features described herein. Secondary particles can be distinct from the abrasive particles based on at least one characteristic selected from the group consisting of particle size, two-dimensional shape, three-dimensional shape, composition, hardness, toughness, friability, density, grain size, agglomeration state, or any combination thereof. In one particular embodiment, the secondary particles can include diluent particles having a hardness less than the hardness of the abrasive particles. In another embodiment, the secondary particles can be randomly shaped abrasive particles.

In one non-limiting embodiment, the coated abrasive article can include secondary particles having an aspect ratio (l:w) of at least 1.1:1, and at least a portion of the secondary particles can have an upright orientation having a tilt angle within a range of greater than 71 degrees to 90 degrees. Control of the orientation of the secondary particles may facilitate improved performance of the coated abrasive article. In certain instances, the coated abrasive article may have at least 5% of the secondary particles oriented at a tilt angle of greater than 71 degrees to 90 degrees, such as at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95% or at least 97% or at least 99% of the secondary particles having a tilt angle of 85 degrees to 90 degrees. In one non-limiting embodiment, the number of secondary particles having an upright orientation may be not greater than 99%, such as not greater than 95% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10% or not greater than 5%. It will be appreciated that the percentage of secondary particles having an upright orientation with a tilt angle within a range of greater than 71 degrees to 90 degrees can be within a range of any of the minimum and maximum percentages noted above, including for example, within a range of at least 10% and not greater than 99% or within a range of at least 50% to not greater than 99% or even within a range of at least 80% and not greater than 99%.

In another embodiment, at least 5% of the secondary particles can be oriented at a tilt angle within a range of greater than 44 degrees to 90 degrees, such as at least 10% or at least 15% or at least 20% or at least 25% or at least 30% or at least 40% or at least 45% or at least 50% or at least 55% or at least 60% or at least 65% or at least 70% or at least 75% or at least 80% or at least 85% or at least 90% or at least 95%. In one non-limiting embodiment, the number of secondary particles having an upright and slanted orientation having a tilt angle within a range of greater than 44 degrees to 90 degrees may be not greater than 99%, such as not greater than 95% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10% or not greater than 5%. It will be appreciated that the percentage of secondary particles having a tilt angle within a range of greater than 44 degrees to 90 degrees can be within a range of any of the minimum and maximum percentages noted above, including for example, within a range of at least 10% and not greater than 99% or within a range of at least 50% to not greater than 99% or even within a range of at least 80% and not greater than 99%.

According to another aspect, at least 5% of the secondary particles can be oriented at a tilt angle within a range of greater than 44 degrees to 71 degrees, such as at least 10% or at least 15% or at least 20% or at least 25% or at least 30% or at least 40% or at least 45% or at least 50% or at least 55% or at least 60% or at least 65% or at least 70% or at least 75% or at least 80% or at least 85% or at least 90% or at least 95%. In one non-limiting embodiment, the number of secondary particles having a slanted orientation with a tilt angle within a range of greater than 44 degrees to 71 degrees may be not greater than 99%, such as not greater than 95% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10% or not greater than 5%. It will be appreciated that the percentage of secondary particles having a tilt angle within a range of greater than 44 degrees to 71 degrees can be within a range of any of the minimum and maximum percentages noted above, including for example, within a range of at least 10% and not greater than 99% or within a range of at least 50% to not greater than 99% or even within a range of at least 80% and not greater than 99%.

In one embodiment, not greater than 50% of the secondary particles can be oriented at a tilt angle of not greater than 44 degrees, such as not greater than 45%, such as not greater than 40% or not greater than 35% or not greater than 30% or not greater than 25% or not greater than 20% or not greater than 15% or not greater than 12% or not greater than 10% or not greater than 8% or not greater than 6% or not greater than 4% or not greater than 2% or not greater than 1%. In one non-limiting embodiment, the content of secondary particles having an flat orientation having a tilt angle of not greater than 44 degrees may be at least 1% or at least 2% or at least 5% or at least 8% or at least 10% or at least 12% or at least 15% or at least 20% or at least 25% or at least 30%. It will be appreciated that the percentage of secondary particles having a tilt angle of not greater than 44 degrees can be within a range of any of the minimum and maximum percentages noted above, including for example, within a range of at least 1% and not greater than 50% or within a range of at least 1% to not greater than 40% or even within a range of at least 80% and not greater than 99%.

Various embodiments herein describe ranges of percentages of particles (abrasive particles and/or secondary particles) having various orientations. While the embodiments have described the particles as percentages, it will be appreciated that for any given article, the total percentage of particles does not exceed 100%. That is, for example, embodiments describe an abrasive article having at least 87% of the abrasive particles oriented at a tilt angle within a range of greater than 44 degrees to 90 degrees, and not greater than 13% of the abrasive particles can be oriented at a tilt angle of not greater than 44 degrees. It will be understood that the total percentage of particles for all orientations will not exceed 100%.

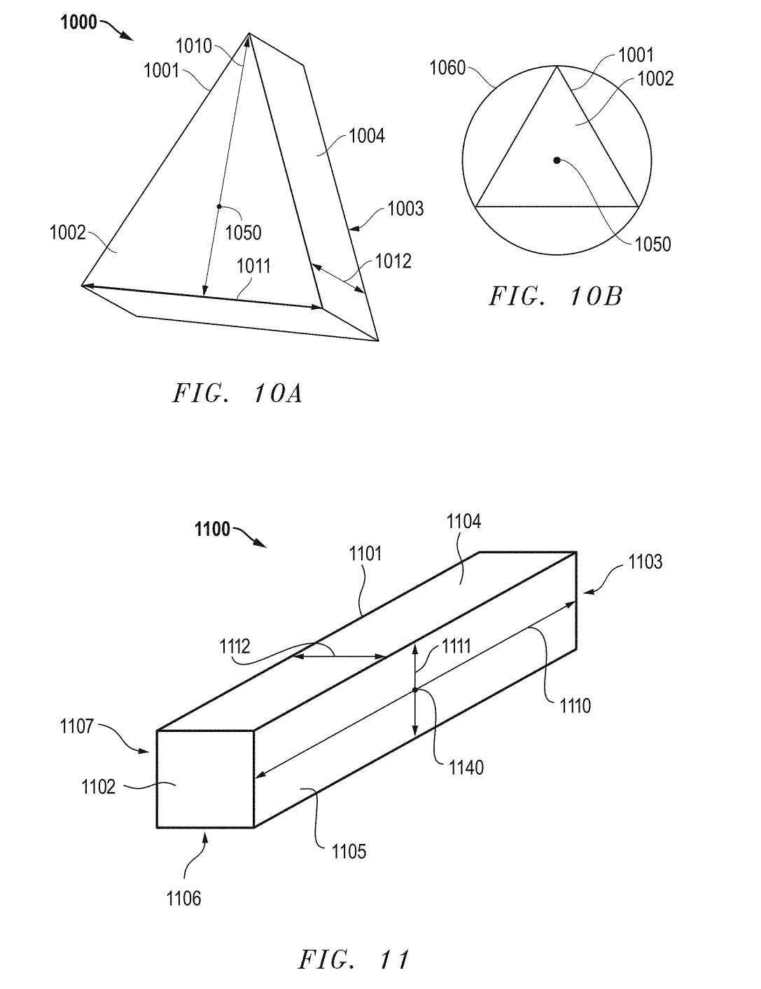

FIG. 9 includes an image of a coated abrasive according to an embodiment. One process for measuring the tilt angle of the particles can include the following process. A coated abrasive article sample is obtained and cleaned to ensure that the particles are clearly visible. If a coated abrasive article includes layers overlying the particles (e.g., size coat, supersize coat, etc.) a gentle sandblasting operation can be conducted to selectively remove the overlying layers and expose the underlying abrasive particles. Care should be taken during the sandblasting operation to ensure that the particles are not damaged or moved. The selective removal operation may be conducted in stages to ensure that only the overlying layers are removed but the underlying particles are not damaged or altered.

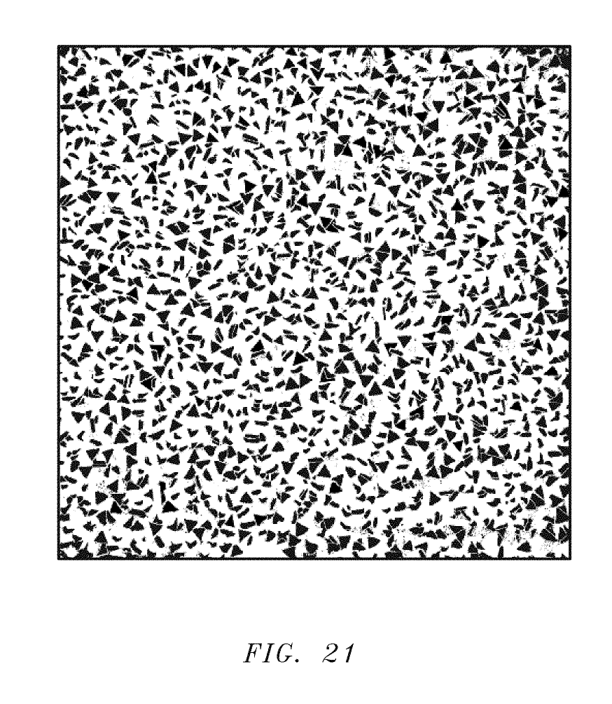

After selectively removing the overlying layers and exposing the particles, top-down images of the surfaces of the abrasive articles are taken. Representative images are provided as FIGS. 17-19 and were obtained using a Cannon Powershot 5110 camera with a resolution of 338 pixels/cm. From these images the eccentricity of an ellipse fit to each particle is calculated. The eccentricity is used to analyze the tilt angle and vertical orientation for each of the particles in the image. This process is completed a minimum number of three times for each sample. Each image is from a randomly selected portion of the abrasive article to obtain a statistically relevant sample set.

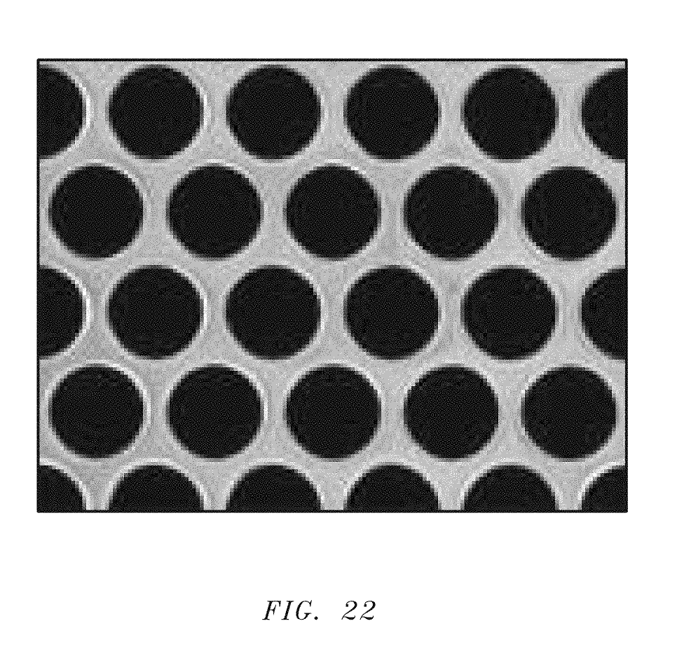

As shown in FIG. 20, the eccentricity of an ellipse fit to a particle as viewed top down can be used to evaluate the vertical orientation of the particle on the backing. As the eccentricity increases, less of the particle is visible from the top-down. Thus, the higher the eccentricity, the more the particle is standing on one of the side surfaces and in an upright orientation compared to a particle with a lower eccentricity where more of the major face is visible. Eccentricity is calculated as E=c/(2a) wherein E is the eccentricity, c is the distance between the foci of the ellipse, and 2a is the length of the major axis of the ellipse. An eccentricity of 0 corresponds to a circle and an eccentricity of 1 is a line segment. Based upon the eccentricity value for a given particle, one may correlate the eccentricity to a tilt angle (B) for each particle relative to the backing. A tilt angle of not greater than 44 degrees corresponds to a particle having a flat orientation, a tilt angle of 45 to not greater than 71 degrees corresponds to a particle having a slanted orientation, and a tilt angle of 71 to 90 degrees corresponds to a particle having an upright orientation.

The original grayscale image of the sample is thresholded to create a black and white image using the Otsu function in the MATLAB software program available from Mathwork Inc. See FIG. 21, as an example of a thresholded image of FIG. 17. Using image analysis software available from ImageJ, the thresholded image is stacked with the original greyscale image and each black region associated with a particle is checked to ensure that individual particles are properly identified and that agglomerates of two or more particles are not combined as a single object in the thresholded image. If the thresholded image does contain agglomerates, the thresholded image is modified in ImageJ by drawing one or more white lines to separate the agglomerate into discrete particles. The greyscale image provides guidance on how to best modify the thresholded image if necessary.

After reviewing and modifying the thresholded image, the thresholded image is analyzed using the “regionprops” function in the MATLAB program. The “regionprops” function calculates a given pixel area and eccentricity of an ellipse for each particle. For those particles having an area not greater than 350 pixels, which appear as points of particles that are not fully visible, such particles are presumed to be upright. For all particles having an area greater than 350 pixels, the eccentricity is used to analyze the tilt angle for each particle. The results are compiled and evaluated to determine the number of particles in the flat orientation, slanted orientation and upright orientation. It will be appreciated that the method disclosed in the foregoing is based in part on the shape fidelity of the particles. For those particles having a low variation in shape and high shape fidelity (e.g., shaped abrasive particles or CTAP) the algorithm for evaluating the tilt angle from the eccentricity may be relatively straightforward. For particles having a greater variation in shape from particle-to-particle, one skilled in the art may find it suitable to adapt the algorithm to calculate tilt angle of the particles based on the measured eccentricity. Moreover, certain types of particles, such as spherical particles, cannot have a tilt angle and thus the methods of the foregoing are inapplicable.

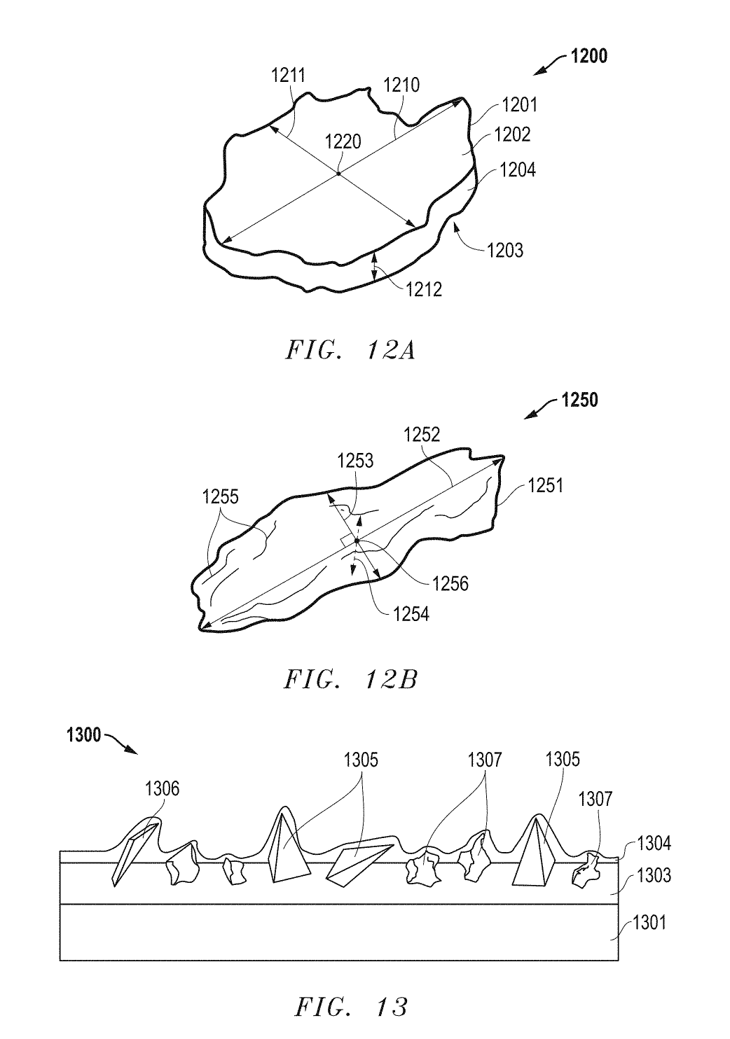

Embodiments herein have made reference to particles, which can include abrasive particles, secondary particles or any combination thereof. Various types of abrasive particles and/or secondary particles can be used with the system and abrasive articles described in the embodiments herein. FIG. 10A includes a perspective view illustration of a shaped abrasive particle in accordance with an embodiment. The shaped abrasive particle 1000 can include a body 1001 including a major surface 1002, a major surface 1003, and a side surface 1004 extending between the major surfaces 1002 and 1003. As illustrated in FIG. 10A, the body 1001 of the shaped abrasive particle 1000 can be a thin-shaped body, wherein the major surfaces 1002 and 1003 are larger than the side surface 1004. Moreover, the body 1001 can include a longitudinal axis 1010 extending from a point to a base and through the midpoint 1050 on a major surface 1002 or 1003. The longitudinal axis 1010 can define the longest dimension of the body along a major surface and through the midpoint 1050 of the major surface 1002.

In certain particles, if the midpoint of a major surface of the body is not readily apparent, one may view the major surface top-down, draw a closest-fit circle around the two-dimensional shape of the major surface and use the center of the circle as the midpoint of the major surface. FIG. 10B includes a top-down illustration of the shaped abrasive particle of FIG. 10A. Notably, the body 1001 includes a major surface 1002 having a triangular two-dimensional shape. The circle 1060 is drawn around the triangular shape to facilitate location of the midpoint 1050 on the major surface 1002.

Referring again to FIG. 10A, the body 1001 can further include a lateral axis 1011 defining a width of the body 1001 extending generally perpendicular to the longitudinal axis 1010 on the same major surface 1002. Finally, as illustrated, the body 1001 can include a vertical axis 1012, which in the context of thin shaped bodies can define a height (or thickness) of the body 1001. For thin-shaped bodies, the length of the longitudinal axis 1010 is greater than the vertical axis 1012. As illustrated, the thickness 1012 can extend along the side surface 1004 between the major surfaces 1002 and 1003 and perpendicular to the plane defined by the longitudinal axis 1010 and lateral axis 1011. It will be appreciated that reference herein to length, width, and height of the abrasive particles may be reference to average values taken from a suitable sampling size of abrasive particles of a larger group, including for example, a group of abrasive particle affixed to a fixed abrasive.

The shaped abrasive particles of the embodiments herein, including thin shaped abrasive particles can have a primary aspect ratio of length:width such that the length can be greater than or equal to the width. Furthermore, the length of the body 1001 can be greater than or equal to the height. Finally, the width of the body 1001 can be greater than or equal to the height. In accordance with an embodiment, the primary aspect ratio of length:width can be at least 1:1, such as at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 1001 of the shaped abrasive particle can have a primary aspect ratio of length:width of not greater than 100:1, not greater than 50:1, not greater than 10:1, not greater than 6:1, not greater than 5:1, not greater than 4:1, not greater than 3:1, not greater than 2:1, or even not greater than 1:1. It will be appreciated that the primary aspect ratio of the body 1001 can be within a range including any of the minimum and maximum ratios noted above.

However, in certain other embodiments, the width can be greater than the length. For example, in those embodiments wherein the body 1001 is an equilateral triangle, the width can be greater than the length. In such embodiments, the primary aspect ratio of length:width can be at least 1:1.1 or at least 1:1.2 or at least 1:1.3 or at least 1:1.5 or at least 1:1.8 or at least 1:2 or at least 1:2.5 or at least 1:3 or at least 1:4 or at least 1:5 or at least 1:10. Still, in a non-limiting embodiment, the primary aspect ratio length:width can be not greater than 1:100 or not greater than 1:50 or not greater than 1:25 or not greater than 1:10 or not greater than 5:1 or not greater than 3:1. It will be appreciated that the primary aspect ratio of the body 1001 can be within a range including any of the minimum and maximum ratios noted above.

Furthermore, the body 1001 can have a secondary aspect ratio of width:height that can be at least 1:1, such as at least 1.1:1, at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 1001 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be within a range including any of the minimum and maximum ratios of above.

In another embodiment, the body 1001 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 1001 can be not greater than 100:1, such as not greater than 50:1, not greater than 10:1, not greater than 8:1, not greater than 6:1, not greater than 5:1, not greater than 4:1, not greater than 3:1. It will be appreciated that the tertiary aspect ratio the body 1001 can be within a range including any of the minimum and maximum ratios and above.

The abrasive particles of the embodiments herein, including the shaped abrasive particles can include a crystalline material, and more particularly, a polycrystalline material. Notably, the polycrystalline material can include abrasive grains. In one embodiment, the body of the abrasive particle, including for example, the body of a shaped abrasive particle can be essentially free of an organic material, such as, a binder. In at least one embodiment, the abrasive particles can consist essentially of a polycrystalline material. In another embodiment, the abrasive particles, such as shaped abrasive particles can be free of silane, and particularly, may not have a silane coating.

The abrasive particles may be made of certain material, including but not limited to nitrides, oxides, carbides, borides, oxynitrides, oxyborides, diamond, carbon-containing materials, and a combination thereof. In particular instances, the abrasive particles can include an oxide compound or complex, such as aluminum oxide, zirconium oxide, titanium oxide, yttrium oxide, chromium oxide, strontium oxide, silicon oxide, magnesium oxide, rare-earth oxides, and a combination thereof.

In one particular embodiment, the abrasive particles can include a majority content of alumina. For at least one embodiment, the abrasive particle can include at least 80 wt % alumina, such as at least 90 wt % alumina, at least 91 wt % alumina, at least 92 wt % alumina, at least 93 wt % alumina, at least 94 wt % alumina, at least 95 wt % alumina, at least 96 wt % alumina, or even at least 97 wt % alumina. Still, in at least one particular embodiment, the abrasive particle can include not greater than 99.5 wt % alumina, such as not greater than 99 wt % alumina, not greater than 98.5 wt % alumina, not greater than 97.5 wt % alumina, not greater than 97 wt % alumina not greater than 96 wt % alumina, or even not greater than 94 wt % alumina. It will be appreciated that the abrasive particles of the embodiments herein can include a content of alumina within a range including any of the minimum and maximum percentages noted above. Moreover, in particular instances, the shaped abrasive particles can be formed from a seeded sol-gel. In at least one embodiment, the abrasive particles can consist essentially of alumina and certain dopant materials as described herein.

The abrasive particles of the embodiments herein can include particularly dense bodies, which may be suitable for use as abrasives. For example, the abrasive particles may have a body having a density of at least 95% theoretical density, such as at least 96% theoretical density, at least 97% theoretical density, at least 98% theoretical density or even at least 99% theoretical density.

The abrasive grains (i.e., crystallites) contained within the body of the abrasive particles may have an average grain size (i.e., average crystal size) that is generally not greater than about 100 microns. In other embodiments, the average grain size can be less, such as not greater than about 80 microns or not greater than about 50 microns or not greater than about 30 microns or not greater than about 20 microns or not greater than about 10 microns or not greater than 6 microns or not greater than 5 microns or not greater than 4 microns or not greater than 3.5 microns or not greater than 3 microns or not greater than 2.5 microns or not greater than 2 microns or not greater than 1.5 microns or not greater than 1 micron or not greater than 0.8 microns or not greater than 0.6 microns or not greater than 0.5 microns or not greater than 0.4 microns or not greater than 0.3 microns or even not greater than 0.2 microns. Still, the average grain size of the abrasive grains contained within the body of the abrasive particle can be at least about 0.01 microns, such as at least about 0.05 microns or at least about 0.06 microns or at least about 0.07 microns or at least about 0.08 microns or at least about 0.09 microns or at least about 0.1 microns or at least about 0.12 microns or at least about 0.15 microns or at least about 0.17 microns or at least about 0.2 microns or even at least about 0.3 microns. It will be appreciated that the abrasive particles can have an average grain size (i.e., average crystal size) within a range between any of the minimum and maximum values noted above.

The average grain size (i.e., average crystal size) can be measured based on the uncorrected intercept method using scanning electron microscope (SEM) photomicrographs. Samples of abrasive grains are prepared by making a bakelite mount in epoxy resin then polished with diamond polishing slurry using a Struers Tegramin 30 polishing unit. After polishing the epoxy is heated on a hot plate, the polished surface is then thermally etched for 5 minutes at 150° C. below sintering temperature. Individual grains (5-10 grits) are mounted on the SEM mount then gold coated for SEM preparation. SEM photomicrographs of three individual abrasive particles are taken at approximately 50,000× magnification, then the uncorrected crystallite size is calculated using the following steps: 1) draw diagonal lines from one corner to the opposite corner of the crystal structure view, excluding black data band at bottom of photo 2) measure the length of the diagonal lines as L1 and L2 to the nearest 0.1 centimeters; 3) count the number of grain boundaries intersected by each of the diagonal lines, (i.e., grain boundary intersections I1 and I2) and record this number for each of the diagonal lines, 4) determine a calculated bar number by measuring the length (in centimeters) of the micron bar (i.e., “bar length”) at the bottom of each photomicrograph or view screen, and divide the bar length (in microns) by the bar length (in centimeters); 5) add the total centimeters of the diagonal lines drawn on photomicrograph (L1+L2) to obtain a sum of the diagonal lengths; 6) add the numbers of grain boundary intersections for both diagonal lines (I1+I2) to obtain a sum of the grain boundary intersections; 7) divide the sum of the diagonal lengths (L1+L2) in centimeters by the sum of grain boundary intersections (I1+I2) and multiply this number by the calculated bar number. This process is completed at least three different times for three different, randomly selected samples to obtain an average crystallite size.

In accordance with certain embodiments, certain abrasive particles can be composite articles including at least two different types of grains within the body of the abrasive particle. It will be appreciated that different types of grains are grains having different compositions with regard to each other. For example, the body of the abrasive particle can be formed such that is includes at least two different types of grains, wherein the two different types of grains can be nitrides, oxides, carbides, borides, oxynitrides, oxyborides, diamond, and a combination thereof.

In accordance with an embodiment, the abrasive particles can have an average particle size, as measured by the largest dimension (i.e., length) of at least about 100 microns. In fact, the abrasive particles can have an average particle size of at least about 150 microns, such as at least about 200 microns, at least about 300 microns, at least about 400 microns, at least about 500 microns, at least about 600 microns, at least about microns, at least about 800 microns, or even at least about 900 microns. Still, the abrasive particles of the embodiments herein can have an average particle size that is not greater than about 5 mm, such as not greater than about 3 mm, not greater than about 2 mm, or even not greater than about 1.5 mm. It will be appreciated that the abrasive particles can have an average particle size within a range between any of the minimum and maximum values noted above.

FIG. 10A includes an illustration of a shaped abrasive particle having a two-dimensional shape as defined by the plane of the upper major surface 1002 or major surface 1003, which has a generally triangular two-dimensional shape. It will be appreciated that the shaped abrasive particles of the embodiments herein are not so limited and can include other two-dimensional shapes. For example, the shaped abrasive particles of the embodiment herein can include particles having a body with a two-dimensional shape as defined by a major surface of the body from the group of shapes including polygons, regular polygons, irregular polygons, irregular polygons including arcuate or curved sides or portions of sides, ellipsoids, numerals, Greek alphabet characters, Latin alphabet characters, Russian alphabet characters, Kanji characters, complex shapes having a combination of polygons shapes, shapes including a central region and a plurality of arms (e.g., at least three arms) extending from a central region (e.g., star shapes), and a combination thereof. Particular polygonal shapes include rectangular, trapezoidal, quadrilateral, pentagonal, hexagonal, heptagonal, octagonal, nonagonal, decagonal, and any combination thereof. In another instance, the finally-formed shaped abrasive particles can have a body having a two-dimensional shape such as an irregular quadrilateral, an irregular rectangle, an irregular trapezoid, an irregular pentagon, an irregular hexagon, an irregular heptagon, an irregular octagon, an irregular nonagon, an irregular decagon, and a combination thereof. An irregular polygonal shape is one where at least one of the sides defining the polygonal shape is different in dimension (e.g., length) with respect to another side. As illustrated in other embodiments herein, the two-dimensional shape of certain shaped abrasive particles can have a particular number of exterior points or external corners. For example, the body of the shaped abrasive particles can have a two-dimensional polygonal shape as viewed in a plane defined by a length and width, wherein the body comprises a two-dimensional shape having at least 4 exterior points (e.g., a quadrilateral), at least 5 exterior points (e.g., a pentagon), at least 6 exterior points (e.g., a hexagon), at least 7 exterior points (e.g., a heptagon), at least 8 exterior points (e.g., an octagon), at least 9 exterior points (e.g., a nonagon), and the like.

FIG. 11 includes a perspective view illustration of a shaped abrasive particle according to another embodiment. Notably, the shaped abrasive particle 1100 can include a body 1101 including a surface 1102 and a surface 1103, which may be referred to as end surfaces 1102 and 1103. The body can further include major surfaces 1104, 1105, 1106, 1107 extending between and coupled to the end surfaces 1102 and 1103. The shaped abrasive particle of FIG. 11 is an elongated shaped abrasive particle having a longitudinal axis 1110 that extends along the major surface 1105 and through the midpoint 1140 between the end surfaces 1102 and 1103. For particles having an identifiable two-dimensional shape, such as the shaped abrasive particles of FIGS. 10 and 11, the longitudinal axis is the dimension that would be readily understood to define the length of the body through the midpoint on a major surface. For example, in FIG. 11, the longitudinal axis 1110 of the shaped abrasive particle 1100 extends between the end surfaces 1102 and 1103 parallel to the edges defining the major surface as shown. Such a longitudinal axis is consistent with how one would define the length of a rod. Notably, the longitudinal axis 1110 does not extend diagonally between the corners joining the end surfaces 1102 and 1103 and the edges defining the major surface 1105, even though such a line may define the dimension of greatest length. To the extent that a major surface has undulations or minor imperfections from a perfectly planar surface, the longitudinal axis can be determined using a top-down, two-dimensional image that ignores the undulations.

It will be appreciated that the surface 1105 is selected for illustrating the longitudinal axis 1110, because the body 1101 has a generally square cross-sectional contour as defined by the end surfaces 1102 and 1103. As such, the surfaces 1104, 1105, 1106, and 17 can be approximately the same size relative to each other. However, in the context of other elongated abrasive particles, the surfaces 1102 and 1103 can have a different shape, for example, a rectangular shape, and as such, at least one of the surfaces 1104, 1105, 1106, and 1107 may be larger relative to the others. In such instances, the largest surface can define the major surface and the longitudinal axis would extend along the largest of those surfaces through the midpoint 1140 and may extend parallel to the edges defining the major surface. As further illustrated, the body 1101 can include a lateral axis 1111 extending perpendicular to the longitudinal axis 1110 within the same plane defined by the surface 1105. As further illustrated, the body 1101 can further include a vertical axis 1112 defining a height of the abrasive particle, wherein the vertical axis 1112 extends in a direction perpendicular to the plane defined by the longitudinal axis 1110 and lateral axis 1111 of the surface 1105.

It will be appreciated that like the thin shaped abrasive particle of FIG. 10, the elongated shaped abrasive particle of FIG. 11 can have various two-dimensional shapes, such as those defined with respect to the shaped abrasive particle of FIG. 10. The two-dimensional shape of the body 1101 can be defined by the shape of the perimeter of the end surfaces 1102 and 1103. The elongated shaped abrasive particle 1100 can have any of the attributes of the shaped abrasive particles of the embodiments herein.

FIG. 12A includes a perspective view illustration of a controlled height abrasive particle according (CHAP) to an embodiment. As illustrated, the CHAP 1200 can include a body 1201 including a first major surface 1202, a second major surface 1203, and a side surface 1204 extending between the first and second major surfaces 1202 and 1203. As illustrated in FIG. 12A, the body 1201 can have a thin, relatively planar shape, wherein the first and second major surfaces 1202 and 1203 are larger than the side surface 1204 and substantially parallel to each other. Moreover, the body 1201 can include a longitudinal axis 1210 extending through the midpoint 1220 and defining a length of the body 1201. The body 1201 can further include a lateral axis 1211 on the first major surface 1202, which extends through the midpoint 1220 of the first major surface 1202, perpendicular to the longitudinal axis 1210, and defining a width of the body 1201.

The body 1201 can further include a vertical axis 1212, which can define a height (or thickness) of the body 1201. As illustrated, the vertical axis 1212 can extend along the side surface 1204 between the first and second major surfaces 1202 and 1203 in a direction generally perpendicular to the plane defined by the axes 1210 and 1211 on the first major surface. For thin-shaped bodies, such as the CHAP illustrated in FIG. 12A, the length can be equal to or greater than the width and the length can be greater than the height. It will be appreciated that reference herein to length, width, and height of the abrasive particles may be referenced to average values taken from a suitable sampling size of abrasive particles of a batch of abrasive particles.

Unlike the shaped abrasive particles of FIGS. 10A, 10B, and 11, the CHAP of FIG. 12A does not have a readily identifiable two-dimensional shape based on the perimeter of the first or second major surfaces 1202 and 1203. Such abrasive particles may be formed in a variety of ways, including but not limited to, fracturing of a thin layer of material to form abrasive particles having a controlled height but with irregularly formed, planar, major surfaces. For such particles, the longitudinal axis is defined as the longest dimension on the major surface that extends through a midpoint on the surface. To the extent that the major surface has undulations, the longitudinal axis can be determined using a top-down, two-dimensional image that ignores the undulations. Moreover, as noted above in FIG. 10B, a closest-fit circle may be used to identify the midpoint of the major surface and identification of the longitudinal and lateral axes.

FIG. 12B includes an illustration of a non-shaped particle, which may be an elongated, non-shaped abrasive particle or a secondary particle, such as a diluent grain, a filler, an agglomerate or the like. Shaped abrasive particles may be formed through particular processes, including molding, printing, casting, extrusion, and the like. Shaped abrasive particles can be formed such that the each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a relatively high shape fidelity and consistency in the arrangement of the surfaces and edges relative to each other. Moreover, constant height abrasive particles (CHAPs) can also be formed through particular processes that facilitate formation of thin-shaped bodies that can have irregular two-dimensional shapes when viewing the major surface top-down. CHAPs can have less shape fidelity than shaped abrasive particles, but can have substantially planar and parallel major surfaces separated by a side surface.

By contrast, non-shaped particles can be formed through different processes and have different shape attributes compared to shaped abrasive particles and CHAPs. For example, non-shaped particles are typically formed by a comminution process wherein a mass of material is formed and then crushed and sieved to obtain abrasive particles of a certain size. However, a non-shaped particle will have a generally random arrangement of surfaces and edges, and generally will lack any recognizable two-dimensional or three dimensional shape in the arrangement of the surfaces and edges. Moreover, non-shaped particles do not necessarily have a consistent shape with respect to each other, and therefore have a significantly lower shape fidelity compared to shaped abrasive particles or CHAPs. The non-shaped particles generally are defined by a random arrangement of surfaces and edges for each particle and with respect to other non-shaped particles

FIG. 12B includes a perspective view illustration of a non-shaped particle. The non-shaped particle 1250 can have a body 1251 including a generally random arrangement of edges 1255 extending along the exterior surface of the body 1251. The body can further include a longitudinal axis 1252 defining the longest dimension of the particle. The longitudinal axis 1252 defines the longest dimension of the body as viewed in two-dimensions. Thus, unlike shaped abrasive particles and CHAPs, where the longitudinal axis is measured on the major surface, the longitudinal axis of a non-shaped particle is defined by the points on the body furthest from each other as the particle is viewed in two-dimensions using an image or vantage that provides a view of the particle's longest dimension. That is, an elongated particle, but non-shaped particles, such as illustrated in FIG. 12B, should be viewed in a perspective that makes the longest dimension apparent to properly evaluate the longitudinal axis. The body 1251 can further include a lateral axis 1253 extending perpendicular to the longitudinal axis 1252 and defining a width of the particle. The lateral axis 1253 can extend perpendicular to the longitudinal axis 1252 through the midpoint 1256 of the longitudinal axis in the same plane used to identify the longitudinal axis 1252. The abrasive particle may have a height (or thickness) as defined by the vertical axis 1254. The vertical axis 1254 can extend through the midpoint 1256 but in a direction perpendicular to the plane used to define the longitudinal axis 1252 and lateral axis 1253. To evaluate the height, one may have to change the perspective of view of the abrasive particle to look at the particle from a different vantage than is used to evaluate the length and width.

As will be appreciated, the abrasive particle can have a length defined by the longitudinal axis 1252, a width defined by the lateral axis 1253, and a vertical axis 1254 defining a height. As will be appreciated, the body 1151 can have a primary aspect ratio of length:width such that the length is equal to or greater than the width. Furthermore, the length of the body 1251 can be equal to or greater than or equal to the height. Finally, the width of the body 1251 can be greater than or equal to the height 1254. In accordance with an embodiment, the primary aspect ratio of length:width can be at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 1251 of the elongated shaped abrasive particle can have a primary aspect ratio of length:width of not greater than 100:1, not greater than 50:1, not greater than 10:1, not greater than 6:1, not greater than 5:1, not greater than 4:1, not greater than 3:1, or even not greater than 2:1. It will be appreciated that the primary aspect ratio of the body 1251 can be within a range including any of the minimum and maximum ratios noted above.

Furthermore, the body 1251 can include a secondary aspect ratio of width:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 1251 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be with a range including any of the minimum and maximum ratios of above.

In another embodiment, the body 1251 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 1251 can be not greater than 100:1, such as not greater than 50:1, not greater than 10:1, not greater than 8:1, not greater than 6:1, not greater than 5:1, not greater than 4:1, not greater than 3:1, It will be appreciated that the tertiary aspect ratio the body 1251 can be with a range including any of the minimum and maximum ratios and above.

The non-shaped particle 1250 can have any of the attributes of abrasive particles described in the embodiments herein, including for example but not limited to, composition, microstructural features (e.g., average grain size), hardness, porosity, and the like.

The abrasive articles of the embodiments herein may incorporate different types of particles, including different types of abrasive particles, different types of secondary particles, or any combination thereof. For example, in one embodiment, the coated abrasive article can include a first type of abrasive particle comprising shaped abrasive particles and a second type of abrasive particle. The second type of abrasive particle may be a shaped abrasive particle or a non-shaped abrasive particle.

FIG. 13 includes a cross-sectional illustration of a coated abrasive article incorporating particulate material in accordance with an embodiment. As illustrated, the coated abrasive 1300 can include a substrate 1301 and a make coat 1303 overlying a surface of the substrate 1301. The coated abrasive 1300 can further include a first type of particulate material 1305 in the form of a first type of shaped abrasive particle, a second type of particulate material 1306 in the form of a second type of shaped abrasive particle, and a third type of particulate material 1307, which may be a secondary particle, such as a diluent abrasive particle, a non-shaped abrasive particle, a filler, and the like. The coated abrasive 1300 may further include size coat 1304 overlying and bonded to the abrasive particulate materials 1305, 1306, 1307, and the make coat 1303.

According to one embodiment, the substrate 1301 can include an organic material, inorganic material, and a combination thereof. In certain instances, the substrate 1301 can include a woven material. However, the substrate 1301 may be made of a non-woven material. Particularly suitable substrate materials can include organic materials, including polymers, and particularly, polyester, polyurethane, polypropylene, polyimides such as KAPTON from DuPont, paper or any combination thereof. Some suitable inorganic materials can include metals, metal alloys, and particularly, foils of copper, aluminum, steel, and a combination thereof.

The make coat 1303 can be applied to the surface of the substrate 1301 in a single process, or alternatively, the particulate materials 1305, 1306, 1307 can be combined with a make coat 1303 material and the combination of the make coat 1303 and particulate materials 1305-1307 can be applied as a mixture to the surface of the substrate 1301. In certain instances, controlled deposition or placement of the particles 1305-1307 in the make coat may be better suited by separating the processes of applying the make coat 1303 from the deposition of the abrasive particulate materials 1305-1307 in the make coat 1303. Still, it is contemplated that such processes may be combined. Suitable materials of the make coat 1303 can include organic materials, particularly polymeric materials, including for example, polyesters, epoxy resins, polyurethanes, polyamides, polyacrylates, polymethacrylates, polyvinylchlorides, polyethylene, polysiloxane, silicones, cellulose acetates, nitrocellulose, natural rubber, starch, shellac, and mixtures thereof. In one embodiment, the make coat 1303 can include a polyester resin. The coated substrate can then be heated in order to cure the resin and the abrasive particulate material to the substrate. In general, the coated substrate 1301 can be heated to a temperature of between about 100° C. to less than about 250° C. during this curing process.

The particulate materials 1305-1307 can include different types of abrasive particles according to embodiments herein. The different types of abrasive particles can include different types of shaped abrasive particles, different types of secondary particles or a combination thereof. The different types of particles can be different from each other in composition, two-dimensional shape, three-dimensional shape, grain size, particle size, hardness, friability, agglomeration, and a combination thereof. As illustrated, the coated abrasive 1300 can include a first type of shaped abrasive particle 1305 having a generally pyramidal shape and a second type of shaped abrasive particle 1306 having a generally triangular two-dimensional shape. The coated abrasive 1300 can include different amounts of the first type and second type of shaped abrasive particles 1305 and 1306. It will be appreciated that the coated abrasive may not necessarily include different types of shaped abrasive particles, and can consist essentially of a single type of shaped abrasive particle. As will be appreciated, the shaped abrasive particles of the embodiments herein can be incorporated into various fixed abrasives (e.g., bonded abrasives, coated abrasive, non-woven abrasives, thin wheels, cut-off wheels, reinforced abrasive articles, and the like), including in the form of blends, which may include different types of shaped abrasive particles, secondary particles, and the like.

The particles 1307 can be secondary particles different than the first and second types of shaped abrasive particles 1305 and 1306. For example, the secondary particles 1307 can include crushed abrasive grit representing non-shaped abrasive particles.

After sufficiently forming the make coat 1303 with the abrasive particulate materials 1305-1307 contained therein, the size coat 1304 can be formed to overlie and bond the abrasive particulate material 1305 in place. The size coat 1304 can include an organic material, may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

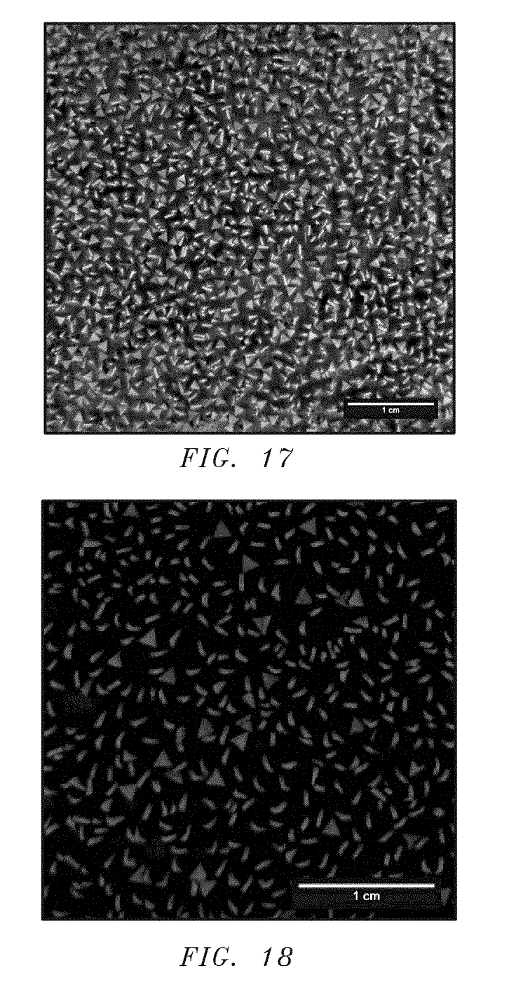

FIG. 14 includes a top view of a portion of a coated abrasive according to an embodiment. The coated abrasive 1400 can include a plurality of regions, such as a first region 1410, a second region 1420, a third region 1430 and a fourth region 1440. Each of the regions 1410, 1420, 1430, and 1440 can be separated by a channel region 1450, wherein the channel region 1450 defines a region the backing that is free of particles. The channel region 1450 can have any size and shape and may be particularly useful for removing swarf and improved grinding operations. The channel region may have a length (i.e., longest dimension) and width (i.e., shortest dimension perpendicular to the length) that is greater than the average spacing between immediately adjacent abrasive particles within any of the regions 1410, 1420, 1430, and 1440. The channel region 1450 is an optional feature for any of the embodiments herein.

As further illustrated, the first region 1410 can include a group of shaped abrasive particles 1411 having a generally random rotational orientation with respect to each other. The group of shaped abrasive particles 1411 can be arranged in a random distribution relative to each other, such that there is no discernable short-range or long-range order with regard to the placement of the shaped abrasive particles 1411. Notably, the group of shaped abrasive particles 1411 can be substantially homogenously distributed within the first region 1410, such that the formation of clumps (two or more particles in contact with each other) is limited. It will be appreciated that the grain weight of the group of shaped abrasive particles 1411 in the first region 1410 can be controlled based on the intended application of the coated abrasive.

The second region 1420 can include a group of shaped abrasive particles 1421 arranged in a controlled distribution relative to each other. Moreover, the group of shaped abrasive particles 1421 can have a regular and controlled rotational orientation relative to each other. As illustrated, the group of shaped abrasive particles 1421 can have generally the same rotational orientation as defined by the same rotational angle on the backing of the coated abrasive 1401. Notably, the group of shaped abrasive particles 1421 can be substantially homogenously distributed within the second region 1420, such that the formation of clumps (two or more particles in contact with each other) is limited. It will be appreciated that the grain weight of the group of shaped abrasive particles 1421 in the second region 1420 can be controlled based on the intended application of the coated abrasive.

The third region 1430 can include a plurality of groups of shaped abrasive particles 1431 and secondary particles 1432. The group of shaped abrasive particles 1431 and secondary particles 1432 can be arranged in a controlled distribution relative to each other. Moreover, the group of shaped abrasive particles 1431 can have a regular and controlled rotational orientation relative to each other. As illustrated, the group of shaped abrasive particles 1431 can have generally one of two types of rotational orientations on the backing of the coated abrasive 1401. Notably, the group of shaped abrasive particles 1431 and secondary particles 1432 can be substantially homogenously distributed within the third region 1430, such that the formation of clumps (two or more particles in contact with each other) is limited. It will be appreciated that the grain weight of the group of shaped abrasive particles 1431 and secondary particles 1432 in the third region 1430 can be controlled based on the intended application of the coated abrasive.

The fourth region 1440 can include a group of shaped abrasive particles 1441 and secondary particles 1442 having a generally random distribution with respect to each other. Additionally, the group of shaped abrasive particles 1441 can have a random rotational orientation with respect to each other. The group of shaped abrasive particles 1441 and secondary particles 1442 can be arranged in a random distribution relative to each other, such that there is no discernable short-range or long-range order. Notably, the group of shaped abrasive particles 1441 and the secondary particles 1442 can be substantially homogenously distributed within the fourth region 1440, such that the formation of clumps (two or more particles in contact with each other) is limited. It will be appreciated that the grain weight of the group of shaped abrasive particles 1441 and secondary particles 1442 in the fourth region 1410 can be controlled based on the intended application of the coated abrasive.

As illustrated in FIG. 14, the coated abrasive article 1400 can include different regions 1410, 1420, 1430, and 1440, each of which can include different groups of particles, such as shaped particles and secondary particles. The coated abrasive article 1400 is intended to illustrate the different types of groupings, arrangements, and distributions of particles that may be created using the systems and processes of the embodiments herein. The illustration is not intended to be limited to only those groupings of particles and it will be appreciated that coated abrasive articles can be made including only one region as illustrated in FIG. 14. It will also be understood that other coated abrasive articles can be made including a different combination or arrangement of one or more of the regions illustrated in FIG. 14.

According to another embodiment, a coated abrasive article may be formed that includes different groups of abrasive particles, wherein the different groups have different tilt angles with respect to each other. For example, as illustrated in FIG. 15, a cross-sectional illustration of a portion of a coated abrasive is provided. The coated abrasive 1500 can include a backing 1501 and a first group of abrasive particles 1501, wherein each of the abrasive particles in the first group of abrasive particles 1501 have a first average tilt angle. The coated abrasive 1500 can further include a second group of abrasive particles 1503, wherein each of the abrasive particles in the second group of abrasive particles 1503 have a second average tilt angle. According to one embodiment, the first group of abrasive particles 1501 and the second group of abrasive particles 1503 can be separated by a channel region 1505. Moreover, the first average tilt angle can be different than the second average tilt angle. In a more particular embodiment, the first group of abrasive particles may be oriented in an upright orientation and the second group of abrasive particles may be oriented in a slanted orientation. Without wishing to be tied to a particular theory, it is thought that controlled variation of the tilt angle for different groups of abrasive particles in different regions of the coated abrasive may facilitate improved performance of the coated abrasive.

According to one particular aspect, the content of abrasive particles overlying the backing can be controlled based on the intended application. For example, the abrasive particles can be overlying at least 5% of the total surface area of the backing, such as at least 10% or at least 20% or at least 30% or at least 40% or at least 50% or at least 60% or at least 70% or at least 80% or at least 90%. In still another embodiment, the coated abrasive article may be essentially free of silane.

Furthermore, the abrasive articles of the embodiments herein can have a particular content of particles overlying the substrate. Moreover, it is noted that for certain contents of particles on the backing, such as open coat densities, the industry has found it challenging to obtain certain contents of particles in desired vertical orientations. In one embodiment, the particles can define an open coat abrasive product having a coating density of particles (i.e., abrasive particles, secondary particles, or both abrasive particles and secondary particles) of not greater than about 70 particles/cm². In other instances, the density of shaped abrasive particle per square centimeter of the abrasive article may be not greater than about 65 particles/cm², such as not greater than about 60 particles/cm², not greater than about 55 particles/cm², or even not greater than about 50 particles/cm². Still, in one non-limiting embodiment, the density of the open coat coated abrasive using the shaped abrasive particle herein can be at least about 5 particles/cm², or even at least about 10 particles/cm². It will be appreciated that the density of shaped abrasive particles per square centimeter of abrasive article can be within a range between any of the above minimum and maximum values.

In certain instances, the abrasive article can have an open coat density of not greater than about 50% of particles (i.e., abrasive particles or secondary particles or the total of abrasive particles and secondary particles) covering the exterior abrasive surface of the article. In other embodiments, the area of the abrasive particles relative to the total area of the surface on which the particles are placed can be not greater than about 40%, such as not greater than about 30%, not greater than about 25%, or even not greater than about 20%. Still, in one non-limiting embodiment, the percentage coating of the particles relative to the total area of the surface can be at least about 5%, such as at least about 10%, at least about 15%, at least about 20%, at least about 25%, at least about 30%, at least about 35%, or even at least about 40%. It will be appreciated that the percent coverage of the particles for the total area of abrasive surface can be within a range between any of the above minimum and maximum values.

Some abrasive articles may have a particular content of particles (i.e., abrasive particles or secondary particles or the total of abrasive particles and secondary particles) for a given area (e.g., ream, wherein 1 ream=30.66 m²) of the backing. For example, in one embodiment, the abrasive article may utilize a normalized weight of particles of at least about 1 lbs/ream (14.8 grams/m²), such as at least 5 lbs/ream or at least 10 lbs/ream or at least about 15 lbs/ream or at least about 20 lbs/ream or at least about 25 lbs/ream or even at least about 30 lbs/ream. Still, in one non-limiting embodiment, the abrasive article can include a normalized weight of particles of not greater than about 90 lbs/ream (1333.8 grams/m²), such as not greater than 80 lbs/ream or not greater than 70 lbs/ream or not greater than 60 lbs/ream or not greater than about 50 lbs/ream or even not greater than about 45 lbs/ream. It will be appreciated that the abrasive articles of the embodiments herein can utilize a normalized weight of particles within a range between any of the above minimum and maximum values.

In certain instances, the abrasive articles can be used on particular workpieces. A suitable exemplary workpiece can include an inorganic material, an organic material, a natural material, and a combination thereof. According to a particular embodiment, the workpiece can include a metal or metal alloy, such as an iron-based material, a nickel-based material, and the like. In one embodiment, the workpiece can be steel, and more particularly, can consist essentially of stainless steel (e.g., 304 stainless steel).

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

### Embodiment 1

A coated abrasive article comprising a backing and abrasive particles overlying the backing, wherein the abrasive particles have a random rotational orientation and at least 87% of the abrasive particles are oriented at a tilt angle of greater than 44 degrees, and wherein not greater than 13% of the abrasive particles are oriented at a tilt angle within a range of 0 degrees to 44 degrees.

### Embodiment 2

A coated abrasive article comprising a backing, abrasive particles overlying the backing, wherein the abrasive particles have a random rotational orientation, and wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and wherein the abrasive particles have a primary orientation value (P1/P2) of at least 2.5.

### Embodiment 3

A coated abrasive article comprising a backing, abrasive particles overlying the backing, wherein the abrasive particles have a random rotational orientation, and wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and a third portion (P3) of the abrasive particles have a flat orientation having a tilt angle within a range of 0 degrees to 44 degrees, and wherein the abrasive particles have a tertiary orientation value (P1/P3) of at least 4.0.

### Embodiment 4

The coated abrasive article of any one of embodiments 1, 2, and 3, wherein the abrasive particles include a first type of abrasive particle comprising shaped abrasive particles.

### Embodiment 5

The coated abrasive article of embodiment 4, wherein the shaped abrasive particles have a triangular two-dimensional shape.

### Embodiment 6

The coated abrasive article of embodiment 4, wherein the shaped abrasive particles have a rectangular two-dimensional shape.

### Embodiment 7

The coated abrasive article of any one of embodiments 5 and 6, wherein each of the shaped abrasive particles have a body, and wherein each body comprises a length (l), a width (w), and a height (h), and wherein l≥w≥h.

### Embodiment 8

The coated abrasive article of any one of embodiments 1, 2, 3, and 4, wherein the abrasive particles include a second type of abrasive particle comprising randomly shaped abrasive particles.

### Embodiment 9

The coated abrasive article of any one of embodiments 1, 2, and 3, wherein the abrasive particles include a first portion (P1) having an upright orientation having a tilt angle within a range of greater than 71 degrees to 90 degrees and a second portion (P2) having a slanted orientation having a tilt angle within a range of greater than 44 degrees to 71 degrees, wherein the abrasive particles have a primary orientation value (P1/P2) of at least 2.5.

### Embodiment 10

The coated abrasive article of any one of embodiments 2 and 9, wherein the abrasive particles have a primary orientation value (P1/P2) of at least 2.6 or at least 2.7 or at least 2.8 or at least 2.9 or at least 3.0 or at least 3.1 or at least 3.2 or at least 3.3 or at least 3.4 or at least 3.5 or at least 3.6.

### Embodiment 11

The coated abrasive article of any one of embodiments 2 and 9, wherein the abrasive particles have a primary orientation value (P1/P2) of not greater than 100 or not greater than 90 or not greater than 80 or not greater than 70 or not greater than 50 or not greater than 30 or not greater than 20 or not greater than 10 or not greater than 9 or not greater than 8 or not greater than 7 or not greater than 6 or not greater than 5 or not greater than 4.

### Embodiment 12

The coated abrasive article of any one of embodiments 1 and 2, wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and a third portion (P3) of the abrasive particles have a flat orientation having a tilt angle within a range of 0 degrees to 44 degrees, and wherein the abrasive particles have a tertiary orientation value (P1/P3) of at least 4.0.

### Embodiment 13

The coated abrasive article of any one of embodiments 3 and 12, wherein the abrasive particles have a tertiary orientation value (P1/P3) of at least 4.5 or at least 5 or at least 5.5 or at least 6 or at least 6.5 or at least 7 or at least 7.5 or at least 8 or at least 8.5 or at least 9 or at least 9.5 or at least 10 or at least 10.5 or at least 11 or at least 11.5 or at least 12 or at least 12.5 or at least 13.

### Embodiment 14

The coated abrasive article of any one of embodiments 3 and 12, wherein the abrasive particles have a tertiary orientation value (P1/P3) of not greater than 100 or not greater than 90 or not greater than 80 or not greater than 70 or not greater than 60 or not greater than 50 or not greater than 40 or not greater than 30 or not greater than 20 or not greater than 18 or not greater than 15 or not greater than 14 or not greater than 13 or not greater than 12 or not greater than 11.

### Embodiment 15

The coated abrasive article of any one of embodiments 1, 2, and 3, wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and a third portion (P3) of the abrasive particles have a flat orientation having a tilt angle within a range of 0 degrees to 44 degrees, and wherein the abrasive particles have an upright-to-slanted and down orientation value (P1/(P2+P3)) of at least 1.5.

### Embodiment 16

The coated abrasive article of embodiment 15, wherein the abrasive particles have an upright-to-slanted and down orientation value (P1/(P2+P3)) of at least 1.6 or at least 1.7 or at least 1.8 or at least 1.9 or at least 2.0 or at least 2.1 or at least 2.2 or at least 2.3 or at least 2.4 or at least 2.5 or at least 2.6 or at least 2.7 or at least 2.8 or at least 2.9 or at least 3.0 or at least 3.2 or at least 3.5 or at least 3.7 or at least 4.0 or at least 4.2 or at least 4.5 or at least 4.7 or at least 5.0 or at least 5.2 or at least 5.5 or at least 5.7 or at least 6.0.

### Embodiment 17

The coated abrasive article of embodiment 15, wherein the abrasive particles have an upright-to-slanted and down orientation value (P1/(P2+P3)) of not greater than 100 or not greater than 90 or not greater than 80 or not greater than 70 or not greater than 60 or not greater than 50 or not greater than 40 or not greater than 30 or not greater than 20 or not greater than 10 or not greater than 8 or not greater than 6.

### Embodiment 18

The coated abrasive article of any one of embodiments 2 and 3, wherein at least 87% of the abrasive particles are oriented at a tilt angle within a range of greater than 44 degrees to 90 degrees.

### Embodiment 19

The coated abrasive article of any one of embodiments 1 and 18, wherein at least 88% of the abrasive particles are oriented at a tilt angle within a range of greater than 44 degrees to 90 degrees or at least 89% or at least 90% or at least 91% or at least 92% or at least 93% or at least 94% or at least 95% or at least 96% or at least 97% or at least 98% or at least 99%.

### Embodiment 20

The coated abrasive article of any one of embodiments 1, 2, and 3, wherein not greater than 12% of the abrasive particles are oriented at a tilt angle of not greater than 44 degrees or not greater than 11% or not greater than 10% or not greater than 9% or not greater than 8% or not greater than 7% or not greater than 6% or not greater than 5% or not greater than 4% or not greater than 3% or not greater than 2% or not greater than 1%.

### Embodiment 21

The coated abrasive article of any one of embodiments 1, 2, and 3, wherein at least 1% of the abrasive particles are oriented at a tilt angle of not greater than 44 degrees or at least 2% or at least 3% or at least 4% or at least 5%.

### Embodiment 22

The coated abrasive article of any one of embodiments 1, 2, and 3, wherein not greater than 25% of the abrasive particles are oriented at a tilt angle within a range of greater than 44 degrees to 71 degrees or not greater than 24% or not greater than 23% or not greater than 22% or not greater than 21% or not greater than 20% or not greater than 19% or not greater than 18% or not greater than 17% or not greater than 16% or not greater than 15% or not greater than 14% or not greater than 13% or not greater than 12% or not greater than 11% or not greater than 10% or not greater than 9% or not greater than 8% or not greater than 5% or not greater than 2%.

### Embodiment 23

The coated abrasive article of any one of embodiments 1, 2, and 3, wherein at least 1% of the abrasive particles are oriented at a tilt angle of greater than 44 degrees to 71 degrees or at least 2% or at least 3% or at least 4% or at least 5% or at least 8% or at least 10%.

### Embodiment 24

The coated abrasive article of any one of embodiments 1, 2, and 3, wherein at least 60% of the abrasive particles are oriented at a tilt angle within a range of greater than 71 degrees to 90 degrees or at least 62% or at least 65% or at least 67% or at least 70% or at least 72% or at least 75% or at least 77% or at least 80% or at least 82% or at least 85% or at least 87% or at least 90% or at least 92% or at least 95% or at least 97%.

### Embodiment 25

The coated abrasive article of any one of embodiments 1, 2, and 3, wherein not greater than 99% of the abrasive particles are oriented at a tilt angle within a range of greater than 71 degrees to 90 degrees or not greater than 98%.

### Embodiment 26

The coated abrasive article of any one of embodiments 1, 2, and 3, further comprising secondary particles having an aspect ratio (l:w) or at least 1.1:1, and wherein at least a portion of the secondary particles have an upright orientation.

### Embodiment 27

The coated abrasive article of embodiment 26, wherein at least 5% of the secondary particles are oriented at a tilt angle within a range of greater than 44 degrees to 90 degrees or at least 10% or at least 15% or at least 20% or at least 25% or at least 30% or at least 40% or at least 45% or at least 50% or at least 55% or at least 60% or at least 65% or at least 70% or at least 75% or at least 80% or at least 85% or at least 90% or at least 95%.

### Embodiment 28

The coated abrasive article of embodiment 26, wherein at least 5% of the secondary particles are oriented at a tilt angle within a range of greater than 71 degrees to 90 degrees or at least 10% or at least 50% or at least 90%.

### Embodiment 29

The coated abrasive article of embodiment 26, wherein not greater than 50% of the secondary particles are oriented at a tilt angle of not greater than 44 degrees or not greater than 40% or not greater than 30% or not greater than 20% or not greater than 15% or not greater than 12% or not greater than 10% or not greater than 8% or not greater than 6% or not greater than 4% or not greater than 2% or not greater than 1%.

### Embodiment 30

The coated abrasive article of embodiment 26, wherein at least 1% of the secondary particles are oriented at a tilt angle of not greater than 44 degrees or at least 2% or at least 3% or at least 5%.

### Embodiment 31

The coated abrasive article of any one of embodiments 1, 2, and 3, further comprising a first group of abrasive particles overlying the backing, wherein the first group of abrasive particles have a first average tilt angle, a second group of abrasive particles overlying the backing, wherein the second group of abrasive particles have a second average tilt angle, the second average tilt angle different than the first average tilt angle, and wherein the first group and second group of abrasive particles are separated by a channel region.

### Embodiment 32

The coated abrasive article of any one of embodiments 1, 2, and 3, wherein the abrasive particles are arranged on the backing in a controlled distribution.

### Embodiment 33

The coated abrasive article of any one of embodiments 1, 2, and 3, wherein the abrasive particles are overlying at least 5% of the total surface area of the backing or at least 10% or at least 20% or at least 30% or at least 40% or at least 50% or at least 60% or at least 70% or at least 80% or at least 90%.

### Embodiment 34

The coated abrasive article of any one of embodiments 1, 2, and 3, further comprising secondary particles overlying the backing, the secondary particles are different from the abrasive particles based on at least one characteristic selected from the group consisting of particle size, two-dimensional shape, three-dimensional shape, composition, hardness, toughness, friability, density, grain size, agglomeration state, or any combination thereof.

### Embodiment 35

The coated abrasive article of embodiment 34, wherein the secondary particles include diluent abrasive particles having a hardness less than a hardness of the abrasive particles.

### Embodiment 36

The coated abrasive article of any one of embodiments 1, 2, and 3, wherein the article is essentially free of silane.

### Embodiment 37

The coated abrasive article of any one of embodiments 1, 2, and 3, wherein the abrasive particles are essentially free of silane.

### Embodiment 38

A method for forming an abrasive article comprising: containing abrasive particles on a substrate; and projecting the abrasive particles from the substrate onto a backing using electrostatic force to project the particles vertically across a gap between the substrate and the backing and onto the backing, wherein the substrate comprises a bulk resistivity of not greater than 1E+14 Ωcm.

### Embodiment 39

A method for forming an abrasive article comprising containing abrasive particles on a substrate, and projecting the abrasive particles from the substrate onto a backing using electrostatic force to project the particles across a gap between the substrate and the backing and onto the backing, wherein projecting is conducted at a projection efficiency of at least 90%.

### Embodiment 40

A method for forming an abrasive article comprising containing abrasive particles on a substrate, the substrate comprising a first portion and a second portion overlying at least some of the first portion, wherein the second portion comprises a resistivity less than a resistivity of the first portion, and wherein the abrasive particles are in contact with the second portion, and projecting the abrasive particles from the substrate onto a backing using electrostatic force.

### Embodiment 41

The method of any one of embodiments 38, 39 and 40, wherein the substrate comprises a bulk resistivity within a range of not less than 1E-6 Ωcm and not greater than 1E+14 Ωcm.

### Embodiment 42

The method of any one of embodiments 38, 39 and 40, wherein projecting is conducted at a projection efficiency of at least 90% or at least 91% or at least 92% or at least 93% or at least 94% or at least 95% or at least 96% or at least 97% or at least 98% or at least 99%.

### Embodiment 43

The method of any one of embodiments 38, 39 and 40, wherein projecting is conducted at a projection efficiency within a range of at least 90% and not greater than 99%.

### Embodiment 44

The method of any one of embodiments 38, 39 and 40, wherein projecting is conducted at a projection efficiency within a range of at least 90% and not greater than 99.9%.

### Embodiment 45

The method of any one of embodiments 38 and 39, wherein the substrate comprises a first portion and a second portion overlying at least some of the first portion, wherein the second portion comprises a resistivity less than a resistivity of the first portion, and wherein the abrasive particles are in contact with the second portion.

### Embodiment 46

The method of any one of embodiments 40 and 45, further comprising a bulk resistivity difference (Δr) of at least 1% between the bulk resistivity of the first portion (r1) and the bulk resistivity of the second portion (r2), wherein the bulk resistivity difference is at least 2% or least 3% or at least 4% or at least 5% or at least 6% or at least 7% or at least 8% or at least 9% or at least 10% or at least 15% or at least 20% or least 25% or at least 30% or at least 35% or at least 40% or at least 45% or at least 50% or at least 55% or at least 60% or at least 65% or at least 70% or least 75% or at least 80% or at least 85% or at least 90% or at least 95%.

### Embodiment 47

The method of any one of embodiments 40 and 45, wherein the first portion comprises a bulk resistivity within a range of not less than 1E+10 Ωcm and not greater than 1E+14 Ωcm.

### Embodiment 48

The method of any one of embodiments 40 and 45, wherein the second portion comprises a bulk resistivity within a range of not less than 1E-6 Ωcm and not greater than 1E+10 Ωcm.

### Embodiment 49

The method of any one of embodiments 38, 39 and 40, wherein projection is conducted in an alternating frequency electric field having a frequency of at least 0.5 Hz and not greater than 40 Hz.

### Embodiment 50

The method of any one of embodiments 38, 39 and 40, wherein the abrasive particles are projected onto an adhesive layer in a random rotational orientation.

### Embodiment 51

The method of any one of embodiments 38, 39 and 40, wherein the substrate comprises at least one containment region and the abrasive particles are contained in the containment region prior to being projected onto the substrate.

### Embodiment 52

The method of embodiment 51, wherein the abrasive particles are projected from the containment region and attached to the substrate with a controlled position.

### Embodiment 53

The method of embodiment 51, wherein the abrasive particles projected from the containment region are attached to the substrate with a controlled rotational orientation.

### Embodiment 54

The method of embodiment 51, wherein the at least one containment region includes at least one opening in the substrate and at least one abrasive particles is at least partially disposed within the at least one opening.

### Embodiment 55

The method of embodiment 51, wherein the at least one containment region comprises at least one of a depression, an opening, a conductive region, or a combination thereof.

### Embodiment 56

The method of any one of embodiments 38, 39 and 40, further comprising an alignment structure positioned between the substrate and the backing and wherein the abrasive particles are projected through openings in the alignment structure to control at least one of a rotational orientation and position of the abrasive particles on the backing.

### Embodiment 57

The method of any one of embodiments 38, 39 and 40, wherein the substrate comprises a material selected from the group consisting of a polymer, metal, metal alloy, ceramic, glass, carbon, or any combination thereof.

### Embodiment 58

The method of any one of embodiments 38, 39 and 40, further comprising projecting secondary particles onto the backing, the secondary particles being different from the abrasive particles based on at least one characteristic selected from the group consisting of particle size, two-dimensional shape, three-dimensional shape, composition, hardness, toughness, friability, density, grain size, agglomeration state, or any combination thereof.

### Embodiment 59

The method of embodiment 58, wherein projecting the secondary particles is conducted simultaneously with the abrasive particles.

### Embodiment 60

The method of any one of embodiments 38, 39 and 40, wherein projection includes a projection inefficiency of not greater than 10% or not greater than 9% or not greater than 8% or not greater than 7% or not greater than 6% or not greater than 5% or not greater than 4% or not greater than 3% or not greater than 2% or not greater than 1%.

### Embodiment 61

The method of any one of embodiments 38, 39 and 40, wherein the substrate comprises a surface resistivity of not less than 1E-6 Ω/sq.

### Embodiment 62

The method of any one of embodiments 38, 39 and 40, wherein the substrate comprises a surface resistivity of not greater than 1E+14 Ω/sq.

### Embodiment 63

The method of any one of embodiments 38, 39 and 40, wherein the substrate comprises a resistivity ratio (Sr/Br) of at least 0.5 cm⁻¹.

### Embodiment 64

The method of any one of embodiments 38, 39 and 40, wherein the substrate comprises a resistivity ratio (Sr/Br) of not greater than 1E+5 cm⁻¹.

### Embodiment 65

A method for forming an abrasive article comprising: containing abrasive particles on a substrate; and projecting the abrasive particles from the substrate onto a backing using electrostatic force to project the particles across a gap between the substrate and the backing and onto the backing, wherein the abrasive particles have a random rotational orientation and at least 87% of the abrasive particles are oriented at a tilt angle of greater than 44 degrees, and wherein not greater than 13% of the abrasive particles are oriented at a tilt angle within a range of 0 degrees to 44 degrees.

### EXAMPLES

### Example 1

Two coated abrasive samples (S1 and S2) were made according to the following conditions. First, shaped abrasive particles were made from a mixture including approximately 45-50 wt % boehmite, which was obtained from Sasol Corporation. One suitable type of commercially available boehmite is Disperal. The boehmite was mixed and seeded with 1% alpha alumina seeds relative to the total alumina content of the mixture. The alpha alumina seeds were made by milling of corundum using conventional techniques, described for example in U.S. Pat. No. 4,623,364. The mixture also included 45-50 wt % water and 2.5-7 wt % additional nitric acid depending on the desired viscosity of the mixture, which were used to form the gel mixture. The ingredients were mixed in a planetary mixer of conventional design and mixed under reduced pressure to remove gaseous elements from the mixture (e.g., bubbles).

After gelling, the mixture was deposited into openings of a production tool made of stainless steel. The openings in the production tool were open to both sides of the production tool, such that they were apertures extending through the entire thickness of the production tool and had an equilateral triangular two-dimensional shape. The surfaces of the openings in the production tool were coated with a lubricant of olive oil to facilitate removal of the precursor shaped abrasive particles from the production tool. The gel mixture was placed in the openings of the production tool and dried for less than 1 minute and removed from the openings using forced air to create precursor shaped abrasive particles. The precursor shaped abrasive particles were sintered between 1250-1400° C. for approximately 10 minutes.

The shaped abrasive particles had a two-dimensional shape of an equilateral triangle having an average length along one side of about 1600 microns and height of approximately 350 microns. The body was formed essentially of a seeded sol-gel alumina material having an average grain size of less than 1 micron.

After forming the shaped abrasive particles, 45 grams of the shaped abrasive particles were placed onto a substrate. The substrate had a first portion and a second portion overlying the first portion. The first portion is available as USO #00003139 from Ammeraal Beltech North America. The first portion had three layers including a bottom layer made of a material identified by the manufacturer as Polam PU, a central layer overlying the bottom layer made of a material identified by the manufacturer as PR3420, and a top layer made of PVC overlying the central layer. The first portion had an average thickness of approximately 3.2 mm and the second portion had an average thickness of approximately 0.25 mm. The substrate had bulk resistivity of 1.79E+12 Ωcm. The first portion had a surface resistivity of 2.12E+12 Ω/sq. The second portion had a bulk resistivity of approximately 2.75×10⁻⁶ Ωcm. The surface resistivity of the second portion is presumed to be the same as the bulk resistivity as the second portion is a metal foil of aluminum. The surface resistivity of the substrate was the same as the surface resistivity of the second portion.

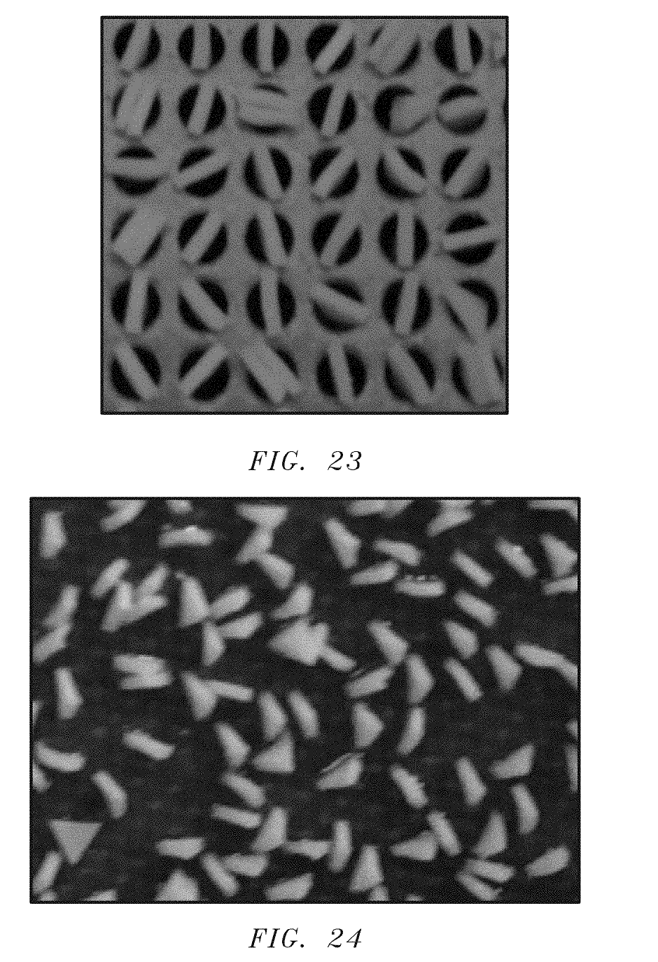

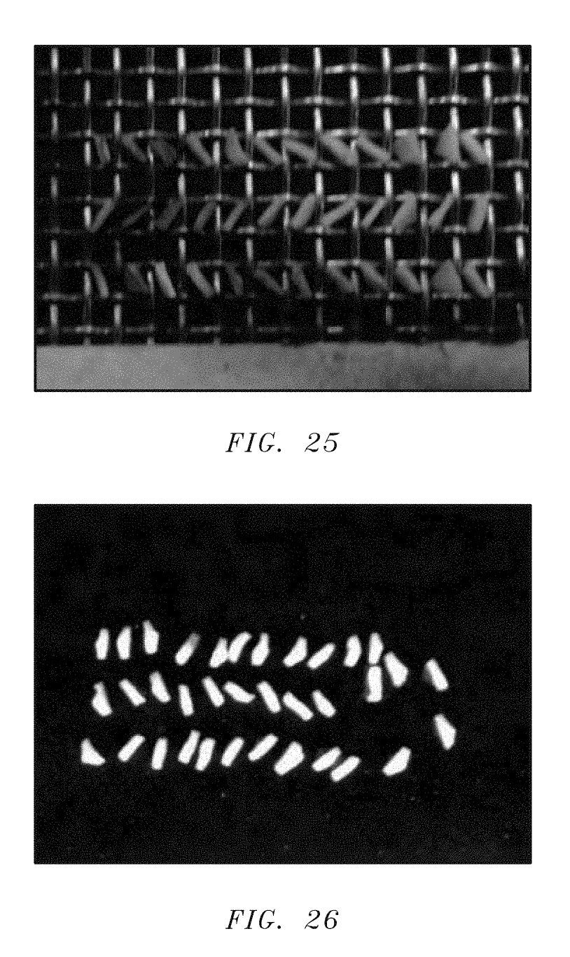

The shaped abrasive particles were shaken to distribute the shaped abrasive particles evenly in openings of a containment region, a portion of which is illustrated in FIG. 22. The containment region was made of steel having circular openings of 0.045 inches in diameter, wherein the openings were spaced apart from each other by approximately 0.07 inches from center to center of the openings. The containment region was directly overlying and in direct contact with the second portion of the substrate. The gap between the electrodes was approximately 0.5 inches. Prior to projection of the particles, a thin layer of phenolic resin (make coat) was applied as noted below. The electric field voltage was set at 15 kV and the frequency was set at 5 Hz and applied for 10 seconds. The shaped abrasive particles were projected from the template onto the backing at an estimated average speed of 0.5 m/s. The coated area with projected grains was approximately 6.25 inches×21 inches. After curing the resin, 15 pictures from different, random locations were taken for orientation analysis. FIG. 23 includes a top-down image of a portion of a containment region including abrasive particles prior to coating on a substrate. FIG. 24 includes a top-down image of a portion of the abrasive article including abrasive particles attached to a backing after a projection process according to an embodiment.

The abrasive particles were formed into a coated abrasive having the construction provided below. Notably, the backing of finished cloth of 45 pounds per ream was obtained and coated with a make formulation including a phenol formaldehyde resin as provided in Table 1. The abrasive particles were projected using the process described above. The structure was dried in an oven for two hours at 80° C. It will be appreciated that the make coat was created such that sum of the components provided in Table 1 equals 100%.

TABLE 1
Make Coat Formulation

| Make Formulation Component | Percentage | |
|---|---|---|
| Filler NYAD Wollastonite 400 | 45-50 | wt % |
| Wet Witcona 1260 | 0.10-.2 | wt % |
| Resin, SI | 45-50 | wt % |
| Solmod Silane A1100 | 0.1-3 | wt % |
| Water | 0.1-1 | wt % |

The coated abrasive structures were then coated with a size coat having the formulation presented in Table 2. The construction was heat treated in an oven set for a final soak temperature of 100-120° C., in which the sample was held for approximately 20-30 minutes. It will be appreciated that the size coat was created such that sum of the components provided in Table 2 equals 100%.

TABLE 2
Size Coat Formulation

| Size Formulation Component | Percentage | |
|---|---|---|
| Dye | 2-4 | wt % |
| Solmod Tamol 165A | 0.5-2 | wt % |
| Filler Syn Cryolite K | 40-45 | wt % |
| Resin Single Comp 94-908 | 50-55 | wt % |
| DF70 Defoamer | 0.1-0.2 | wt % |
| Water | 2-4 | wt % |

The coated abrasive sample was then placed into an oven to undergo heat treatment. The oven temperature was set for a final soak temperature of approximately 110-120° C., in which the sample was held for approximately 10-12 hours.

A supersize coat having the formulation provided below in Table 3 was then applied and processed in the same manner as the size coat. It will be appreciated that the supersize coat was created such that sum of the components provided in Table 3 equals 100%.

TABLE 3
Supersize Coat Formulation

| Supersize Formulation Component | Percentage | |
|---|---|---|
| Dye | 1-3 | wt % |
| Solmod Cabosil | 0.05-3 | wt % |
| Solmod DAXAD 11 | 1-4 | wt % |
| Potassium Tetrafluoroborate | 63-67 | wt % |
| Resin PF Prefere 80-5080A | 20-25 | wt % |
| DF70 Defoamer | 0.1-0.2 | wt % |
| Water | 6-10 | wt % |

A conventional coated abrasive article (i.e., Sample CS1) commercially available from 3M as 984F was also obtained and analyzed. The adhesive layers were removed using a sandblasting process as described herein and the orientation of the particles was analyzed using the processes described herein.

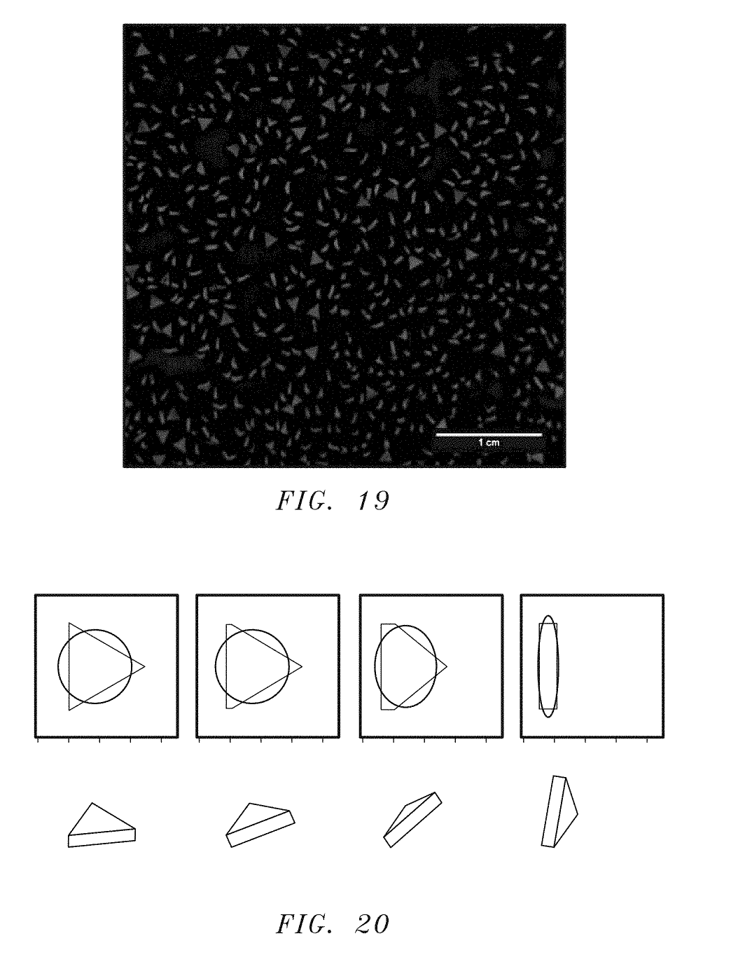

FIG. 16 includes a plot illustrating the orientation of shaped abrasive particles in each of the samples. As illustrated, the representative samples differ significantly in the percentage of grains in the upright, slanted and down orientations.

### Example 2

A second sample was made using the abrasive particles of Example 1. Thirty-six shaped abrasive particles were placed into the openings of a containment region as shown in FIG. 25. The containment region was made of silver and was attached to a top layer of a substrate available as USO #00003139 from Ammeraal Beltech North America. The substrate had three layers including a bottom layer made of a material identified by the manufacturer as Polam PU, a central layer overlying the bottom layer made of a material identified by the manufacturer as PR3420, and a top layer made of PVC overlying the central layer. The substrate had bulk resistivity of 1.79E+12 Ωcm. The containment region had a bulk resistivity of 1.59E-6 Ω/sq. The surface resistivity of the second portion is presumed to be the same as the bulk resistivity as the second portion was made of silver.

The containment region had openings of approximately 0.05 inches in width. The gap between the electrodes was approximately 0.5 inches. Prior to projection of the particles, a double sided adhesive tape (Saint-Gobain Norbond® product Z545H), 1.1 mm thick, was applied to the top electrode. The electric field voltage was set at 30 kV and the frequency was set at 5 Hz and applied for 10 seconds. The shaped abrasive particles were projected from the template onto the backing at an estimated average speed of 0.5 m/s.

FIG. 26 includes a top down image of the abrasive particles attached to the adhesive tape. Notably, the particles demonstrate remarkable registration in their tilt angle orientation and rotational orientation compared to their original positions within the containment region.

Certain prior art has disclosed that it is desirable to orient particles in an upright manner using electrostatic projection. See, for example, WO 20120112322. In fact, certain prior art references have even depicted idealized drawings of coated abrasive articles having a high content of abrasive particles in an upright orientation. See for example, US 20130344786. However, despite these disclosures, the industry continues to be based on coated abrasive articles having limited numbers of particles in the desired orientations. Empirical studies of state-of-the-art, commercially available coated abrasives, which were completed by the Applicants, show that coated abrasive articles have a significant portion of the particles in undesirable orientations. The present systems and methods enable the efficient formation of coated abrasive articles having improved control of the orientation of particles. Based on Applicants knowledge, the embodiments herein provide a commercial scale method for producing coated abrasive articles having certain levels of orientation of the particles that has not previously been achieved.

Moreover, certain projection systems may have previously considered using conductive substrate materials, such as a metal. However, it is also recognized in the industry that use of a metal substrate brings about significant health and safety concerns, as the metal belt must be proper insulated, otherwise people and other adjacent electronic devices may be susceptible to discharges from the electrified belt.

The present application represents a departure from the state of the art. While certain publications have disclosed that it is desirable to orient shaped abrasive particles in certain orientations these publications have not enabled the degree of orientation as disclosed in the present application. Empirical studies have been completed on state-of-the-art coated abrasive articles and it has been noted that such abrasives do not have the degree of orientation (i.e., tilt angle) as disclosed in current literature. That is, while the literature appears to suggest that such systems enable the formation of abrasive articles with a significant portion of particles in an upright orientation, in reality, it is noted that the state of the art coated abrasives do not correlate or enable the degree of orientation achieved by the processes and systems disclosed herein. Notably, it is apparent that conventional coated abrasives actually have a significant portion of abrasive particles placed in undesirable orientations. The industry continues to desire an enabled system and method for achieving a greater degree of control of orientation of abrasive particles in coated abrasives. The system and methods disclosed herein enable the formation of a coated abrasive articles having greater control over the orientation of particles on a backing for creation of coated abrasive articles. Moreover, the systems and methods herein may facilitate improved fine-tuned control over certain orientations, such as control over upright, slanted and flat orientations of grains.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. A coated abrasive article comprising:
a backing; and
abrasive particles overlying the backing, wherein the abrasive particles have a random rotational orientation and at least 87% of the abrasive particles are oriented at a tilt angle of greater than 44 degrees, and wherein not greater than 13% of the abrasive particles are oriented at a tilt angle within a range of 0 degrees to 44 degrees.

2. The coated abrasive article of claim 1, wherein the abrasive particles include a first type of abrasive particle comprising shaped abrasive particles.

3. The coated abrasive article of claim 2, wherein the shaped abrasive particles have a triangular two-dimensional shape.

4. The coated abrasive article of claim 2, wherein the shaped abrasive particles have a rectangular two-dimensional shape.

5. The coated abrasive article of claim 2, wherein each of the shaped abrasive particles have a body, and wherein each body comprises a length (l), a width (w), and a height (h), and wherein l≥w≥h.

6. The coated abrasive article of claim 1, wherein the abrasive particles include a second type of abrasive particle comprising randomly shaped abrasive particles.

7. The coated abrasive article of claim 1, wherein at least 1% of the abrasive particles are oriented at a tilt angle of not greater than 44 degrees.

8. The coated abrasive article of claim 1, wherein at least 1% of the abrasive particles are oriented at a tilt angle of greater than 44 degrees to 71 degrees.

9. The coated abrasive article claim 1 wherein at least 60% of the abrasive particles are oriented at a tilt angle within a range of greater than 71 degrees to 90 degrees.

10. The coated abrasive article of claim 1, further comprising secondary particles having an aspect ratio (l:w) or at least 1.1:1, and wherein at least a portion of the secondary particles have an upright orientation.

11. The coated abrasive article of claim 10, wherein at least 5% of the secondary particles are oriented at a tilt angle within a range of greater than 44 degrees to 90 degrees.

12. The coated abrasive article of claim 10, wherein at least 5% of the secondary particles are oriented at a tilt angle within a range of greater than 71 degrees to 90 degrees.

13. The coated abrasive article of claim 10, wherein not greater than 50% of the secondary particles are oriented at a tilt angle of not greater than 44 degrees.

14. A coated abrasive article comprising:
a backing;
abrasive particles overlying the backing, wherein the abrasive particles have a random rotational orientation, and wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and wherein the abrasive particles have a primary orientation value (P1/P2) of at least 2.5.

15. The coated abrasive article of claim 14, wherein the abrasive particles have a primary orientation value (P1/P2) of not greater than 100.

16. The coated abrasive article of claim 14, wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and a third portion (P3) of the abrasive particles have a flat orientation having a tilt angle within a range of 0 degrees to 44 degrees, and wherein the abrasive particles have a tertiary orientation value (P1/P3) of at least 4.0.

17. The coated abrasive article of claim 14, wherein a first portion (P1) of the abrasive particles have an upright orientation having a tilt angle within a range of greater than 71 degrees to 90 degrees, a second portion (P2) of the abrasive particles have a slanted orientation having a tilt angle within a range of greater than 44 degrees to 71 degrees, and a third portion (P3) of the abrasive particles have a flat orientation having a tilt angle within a range of 0 degrees to 44 degrees, and wherein the abrasive particles have an upright-to-slanted and down orientation value (P1/(P2+P3)) of at least 1.5.

18. The coated abrasive article of claim 14, wherein at least 87% of the abrasive particles are oriented at a tilt angle within a range of greater than 44 degrees to 90 degrees.

19. The coated abrasive article of claim 14, wherein not greater than 25% of the abrasive particles are oriented at a tilt angle within a range of greater than 44 degrees to 71 degrees.

20. The coated abrasive article of claim 14, wherein not greater than 99% of the abrasive particles are oriented at a tilt angle within a range of greater than 71 degrees to 90 degrees.
